(19) United States
(12) Patent Application Publication
(10) Pub. No.: US 2025/0045009 A1
(43) Pub. Date: Feb. 6, 2025

(54) EDGE DATA CACHING IN A MEDIA PLAYBACK SYSTEM

(71) Applicant: Sonos, Inc., Santa Barbara, CA (US)

(72) Inventors: Daniel Casimiro, Boston, MA (US); Kyle Seaman, Bedford, MA (US); Angela Breuer, Somerville, MA (US); Keith Thoresz, Belmont, MA (US); Ryan Moak, Boston, MA (US)

(21) Appl. No.: 18/682,392

(22) PCT Filed: Aug. 8, 2022
(86) PCT No.: PCT/US2022/074647

§ 371 Date: Feb. 8, 2024

Related U.S. Application Data
(60) Provisional application No. 63/231,573, filed on Aug. 10, 2021.

(51) Int. Cl. G06F 3/16; H04R 3/12; H04R 27/00

(52) U.S. Cl. CPC G06F 3/162; H04R 3/12; H04R 27/00; H04R 2227/003; H04R 2227/005

(57) ABSTRACT

Examples described herein involve edge data caching in a media playback system. A media play back system may include playback devices that controllable using a controller, such as a control application installed on a mobile device via network messaging (e.g., via a LAN). Yet further, cloud servers may provide platform services that support the playback devices and the controllers of the media playback system. In example systems, edge computing resources of the players are leveraged to offload storage and processing that would otherwise be performed in the cloud (i.e., by the platform servers). For instance, within a media playback system, one or more players may cache data hosted by the platform servers (e.g., state information), thereby allowing some requests from clients such as the controllers and other players to be handled locally rather than by the platform servers in the cloud.

### CROSS-REFERENCE TO RELATED APPLICATION

The present application claims the benefit of priority to U.S. Patent Application No. 63/231,573, filed Aug. 10, 2021, which is incorporated herein by reference in its entirety.

### FIELD OF THE DISCLOSURE

The present technology relates to consumer goods and, more particularly, to methods, systems, products, features, services, and other elements directed to voice-assisted control of media playback systems or some aspect thereof.

### BACKGROUND

Options for accessing and listening to digital audio in an out-loud setting were limited until in 2002, when SONOS, Inc. began development of a new type of play back system. Sonos then filed one of its first patent applications in 2003, entitled “Method for Synchronizing Audio Playback between Multiple Networked Devices,” and began offering its first media play back systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to play back devices such that each room with a playback device can play back corresponding different media content. In addition, rooms can be grouped together for synchronous play back of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings where:

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media play back system configured in accordance with aspects of the disclosed technology.

FIG. 1B is a schematic diagram of the media playback system of FIG. 1A and one or more networks.

FIG. 2A is a functional block diagram of an example playback device.

FIG. 2B is an isometric diagram of an example housing of the playback device of FIG. 2A.

FIG. 2C is a diagram of an example voice input.

FIG. 2D is a graph depicting an example sound specimen in accordance with aspects of the disclosure.

FIGS. 3A, 3B, 3C, 3D and 3E are diagrams showing example playback device configurations in accordance with aspects of the disclosure.

FIG. 4 is a functional block diagram of an example controller device in accordance with aspects of the disclosure.

FIGS. 5A and 5B are controller interfaces in accordance with aspects of the disclosure.

FIG. 6 is a message flow diagram of a media playback system.

FIG. 7 is a functional block diagram illustrating an example edge data caching architecture in accordance with aspects of the disclosed technology.

FIGS. 8A and 8C are example message flow diagrams illustrating example edge data caching in accordance with aspects of the disclosed technology.

FIGS. 9A, 9B, and 9C are functional block diagrams illustrating example edge data caching in accordance with aspects of the disclosed technology.

FIGS. 10A, 10B, and 10C are example message flow diagrams illustrating example authorization management in accordance with aspects of the disclosed technology.

FIGS. 11A, 11B, and 11C are functional block diagrams illustrating example authorization management in accordance with aspects of the disclosed technology.

FIG. 12 is a flow diagram of an example method to edge data cache in accordance with aspects of the disclosed technology.

FIG. 13 is a flow diagram of an example method to process command intermediates in accordance with aspects of the disclosed technology.

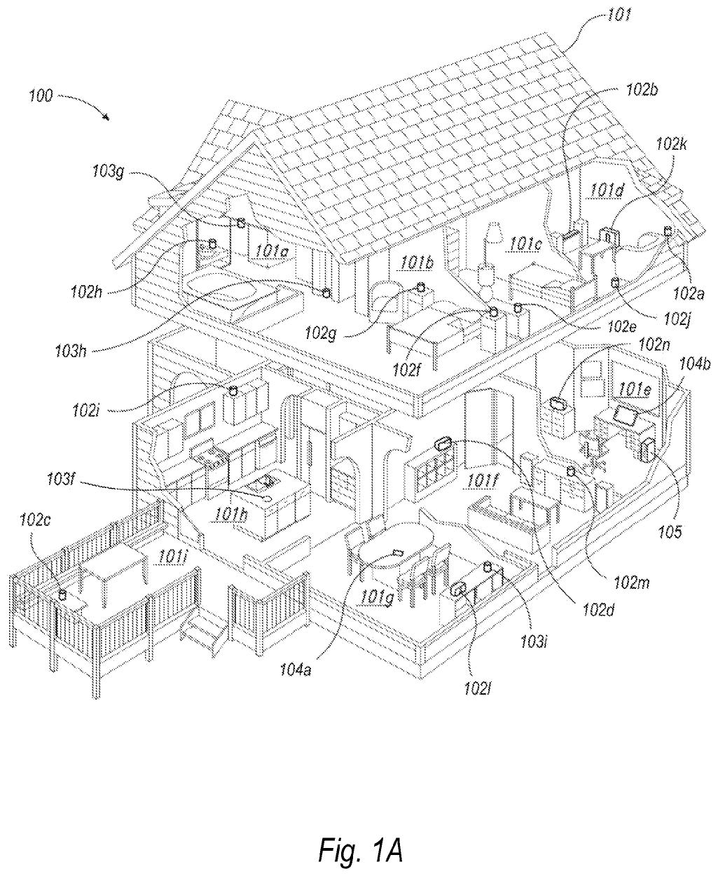

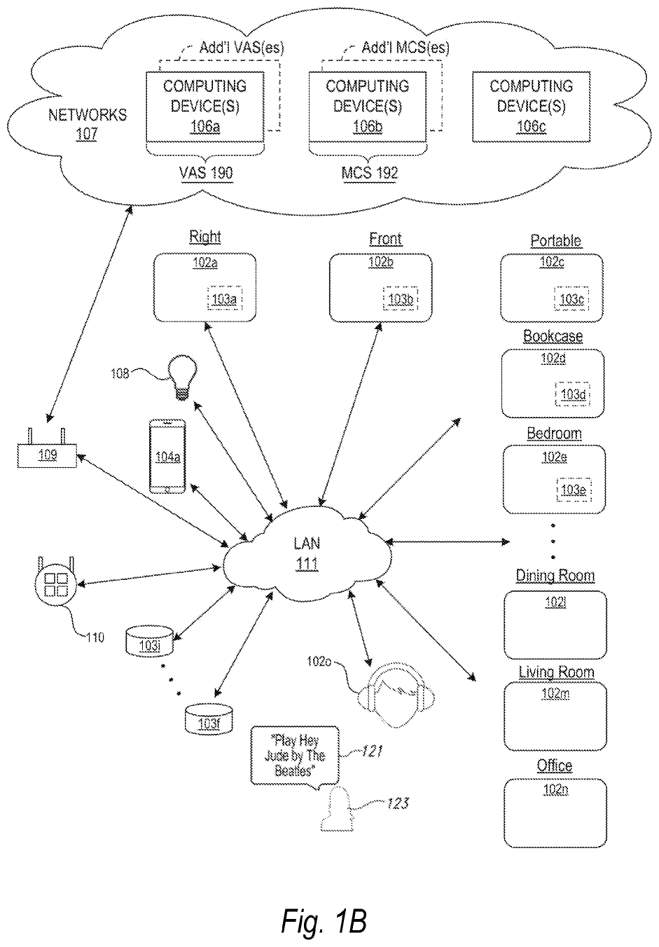

The drawings are for purposes of illustrating example embodiments, but it should be understood that the inventions are not limited to the arrangements and instrumentality shown in the drawings. In the drawings, identical reference numbers identify at least generally similar elements. To facilitate the discussion of any particular element, the most significant digit or digits of any reference number refers to the Figure in which that element is first introduced. For example, element 103a is first introduced and discussed with reference to FIG. 1A.

### DETAILED DESCRIPTION

### I. Overview

Example techniques described herein involve edge data caching in a media play back system. A media play back system may include one or more playback devices (also referred to as “players”), which may take the form of “smart” speakers having, in some examples, integrated processors, memory, network interfaces, operating systems, one or more sensors such as a microphone, and applications configured to perform audio playback and related functions. Such audio playback and other functions of the play back device(s) are controllable using a controller, such as a control application installed on another computing device (e.g., a mobile device or laptop) via network messaging (e.g., via a local area network). Yet further, one or more cloud servers, referred to herein as platform servers, may provide platform services that support the play back devices and the controllers of the media play back system.

The three-component architecture of player, controller, and server is unique when compared to a more traditional two-component web architecture of client and server. In a sense, the controllers are akin to clients, as they may operate as a front-end to the players (and/or to the servers). By providing platforming services, the platform servers of the three-component architecture share some similarities with servers in a more traditional two-component web architecture. However, unlike a client-server architecture, the players may operate as clients (e.g., of the cloud, or to other players on the network) and also as servers (e.g., with respect to other playback devices or controllers). Further, any of the three components may be generating data, storing data, or using data during operation of the media play back system.

To facilitate system operation, information in the form of data is shared among the components. For instance, a controller may request system topology data (e.g., indicating player room assignments, groups, queues, and playback state, among other data) and then display a representation of such information on a graphical user interface. Other types of information include services data (e.g., the registered content and/or voice assistant services), user personalization (e.g., favorites and playlists), and settings, among other examples. This information may be referred to collectively as state information.

Since this state information exists in different locations within the media playback system, different versions may come to exist. To reconcile different versions, the system may implement a protocol in which the system maintains one version as a “source of truth” of the state information. In an example, while providing various platform services, the platform servers may host the state information and operate as a “source of truth” among the various components. The platform servers may service requests for the state information from clients such as the players and the controllers.

In contrast to platform servers located in the cloud, the playback devices are located relatively proximate or near the user (i.e., at the “edge” of components that are local to the user), so that the user can use the playback devices for media playback. As noted above, players may have integrated processors, memory, and network interfaces to facilitate playback functions and related functions. During operation, these components might not be fully utilized. As such, the play back devices may have spare computing resources that can provide edge computing resources. This edge computing might be low cost and/or “free” in the sense that these computing resources already exist in the player and are not fully utilized in performing the playback functions.

Some example techniques involve leveraging the edge computing resources of the players to offload storage and processing that might otherwise be performed in the cloud (i.e., by the platform servers). For instance, within a media playback system, one or more players may cache data hosted by the platform servers (e.g., state information), thereby allowing some requests from clients such as the controllers, other players, and/or other IoT devices (appliances, switches, lights, sensors, and the like) within the household to be handled locally rather than by the platform servers in the cloud. Potentially, such edge caching may result in the benefits of faster response time (as the player is physically nearer to the client and/or on the same local network, which may allow the play back device to respond faster) and/or reduced cloud calls (and attendant costs).

In an example, a player may operate as a “gateway” or “point-of-contact” to the cloud. A gateway player may handle various requests, such as authorization and service requests, from clients, such as the controllers, other players, and/or other IoT devices within the household, using cached state information. If the gateway player is unable to handle a request (e.g., because it does not have corresponding state information cached or its cached data is stale), the gateway player may request this data from the cloud and, after receiving the requested data, respond to the requesting client. The gateway player may also update its edge data cache with the requested data to facilitate fulfilling subsequent requests locally using the edge data cache rather than the cloud. Yet further, the gateway(s) of a media play back system may perform storage and processing on behalf of players, controllers, or other IoT devices in other households.

While a three-component architecture of player, controller, and server is provided by way of example, example techniques may also be implemented in variations of such an architecture. For instance, another architecture may include a first player, a second player, and a server, where the first player caches on behalf of the second player. Moreover, in some implementations, a device may implement a player and a controller, such that the player portion of the device caches on behalf of the controller portion, and/or on behalf of other devices within the systems. While such devices and components are provided by way of example to illustrate an example operating environment, example techniques may be performed using different devices, perhaps with additional or fewer components.

Within examples, some media playback systems include multiple playback devices and/or multiple controllers. For instance, an example household may have a plurality of players in different rooms, as well as multiple users each with their own controller(s). In such an example, a gateway playback device may handle requests from multiple controllers, thereby increasing the benefits of edge caching as cached data can potentially be used to avoid cloud calls for the same data from multiple controllers.

In some cases, more than one playback device may operate as the gateway. In operation, they may cache different data, as they receive different requests for data from various clients. For instance, a particular controller may be configured to interact with the media play back system via a particular gateway, which, over time, may cause the edge data cache of that gateway to become personalized to that controller by including cached data that the particular controller has requested (and so may be more likely to request again).

The edge computing techniques disclosed herein may be utilized to enhance user privacy and/or security. Cloud services may rely on user data to improve their services (especially with artificial intelligence based platforms), but such improvements may come at the cost of user privacy (since the cloud logs the user's data and interaction) and security (since the user data is now available to be breached). When more computing takes place at the edge, on the user's own devices, rather than in the cloud, less user data may ultimately be sent to the cloud, thereby inherently enhancing user privacy and security.

Edge computing may be suited to a commercial environment. Example commercial environments, such as restaurants, bars, venues, and the like, may have many controllers, as many persons with control devices may be present in such an environment. Yet, the permission of such “guest” controllers may be limited (e.g., to viewing certain playback state information, such as now playing). In such an example, cached state information may be used to provide many such guest controllers with state information, which may avoid many cloud calls by such guest controllers.

Edge computing may also be beneficial when the Internet is not available (e.g., because of an outage) or limited (e.g., when on the go with a portable playback device). For example, if certain data is cached locally, such as play back history, the cached data may be utilized to avoid a disruption in functionality. In some examples, such as in a commercial setting, some content itself may be cached to allow playback of that content in the absence of an Internet connection. A portable playback device might not have a mobile Internet connection or might be taken to a location without reliable cellular service. In such circumstances, cached data on the portable playback device may be used to avoid disruption in functionality.

As noted above, example techniques relate to edge data caching in a media play back system. An example implementation involves a system comprising a playback device, wherein the first playback device comprises, a network interface, at least one processor and data storage including instructions that are executable by the at least one processor such that the playback device is configured to: determine that a first version of state information corresponding to the playback device cached in the edge data cache is stale, wherein the play back device is connected to a local area network (LAN): after determining that the first version of the state information cached in the edge data cache is stale, send, via the network interface to a computing system, data representing a first request for the state information corresponding to the play back device, wherein the computing system is outside of the LAN: after receipt of data representing a second version of the state information corresponding to the playback device, cache, in the edge data cache, the second version of the state information of the state information corresponding to the play back device: send, via the network interface to a network device, a first response comprising first data representing the second version of the state information: determine that the second version of the state information corresponding to the play back device cached in the edge data cache is not stale; and after determining that the second version of the state information cached in the edge data cache is not stale, send, via the network interface, a second response comprising second data representing the second version of the state information cached in the edge data cache.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

### II. Example Operation Environment

FIGS. 1A and 1B illustrate an example configuration of a media play back system 100 (or “MPS 100”) in which one or more embodiments disclosed herein may be implemented. Referring first to FIG. 1A, the MPS 100 as shown is associated with an example home environment having a plurality of rooms and spaces, which may be collectively referred to as a “home environment,” “smart home,” or “environment 101.” The environment 101 comprises a household having several rooms, spaces, and/or playback zones, including a master bathroom 101a, a master bedroom 101b, (referred to herein as “Nick's Room”), a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the MPS 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

Within these rooms and spaces, the MPS 100 includes one or more computing devices. Referring to FIGS. 1A and 1B together, such computing devices can include playback devices 102 (identified individually as playback devices 102a-102n), network microphone devices 103 (identified individually as “NMDs” 103a-102i), and controller devices 104a and 104b (collectively “controller devices 104”). Referring to FIG. 1B, the home environment may include additional and/or other computing devices, including local network devices, such as one or more smart illumination devices 108 (FIG. 1B), a smart thermostat 110, and a local computing device 105 (FIG. 1A).

With reference still to FIG. 1B, the various playback, network microphone, and controller devices 102, 103, and 104 and/or other network devices of the MPS 100 may be coupled to one another via point-to-point connections and/or over other connections, which may be wired and/or wireless, via a network 111, such as a LAN including a network router 109. For example, the playback device 102j in the Den 101d (FIG. 1A), which may be designated as the “Left” device, may have a point-to-point connection with the play back device 102a, which is also in the Den 101d and may be designated as the “Right” device. In a related embodiment, the Left play back device 102j may communicate with other network devices, such as the playback device 102b, which may be designated as the “Front” device, via a point-to-point connection and/or other connections via the NETWORK 111.

As further shown in FIG. 1B, the MPS 100 may be coupled to one or more remote computing devices 106 via a wide area network (“WAN”) (i.e., the Internet), labeled here as the networks 107. In some embodiments, each remote computing device 106 may take the form of one or more cloud servers. The remote computing devices 106 may be configured to interact with computing devices in the environment 101 in various ways. For example, the remote computing devices 106 may be configured to facilitate streaming and/or controlling playback of media content, such as audio, in the home environment 101.

In some implementations, the various playback devices, NMDs, and/or controller devices 102-104 may be communicatively coupled to at least one remote computing device associated with a VAS and at least one remote computing device associated with a media content service (“MCS”). For instance, in the illustrated example of FIG. 1B, remote computing devices 106 are associated with a VAS 190 and remote computing devices 106b are associated with an MCS 192. Although only a single VAS 190 and a single MCS 192 are shown in the example of FIG. 1B for purposes of clarity, the MPS 100 may be coupled to multiple, different VASes and/or MCSes. In some implementations, VASes may be operated by one or more of AMAZON, GOOGLE, APPLE, MICROSOFT, SONOS or other voice assistant providers. In some implementations, MCSes may be operated by one or more of SPOTIFY, PANDORA, AMAZON MUSIC, or other media content services. Media content services are also referred to herein as streaming audio services.

As further shown in FIG. 1B, the remote computing devices 106 further include remote computing device 106c configured to perform certain operations, such as remotely facilitating media playback functions, managing device and system status information, directing communications between the devices of the MPS 100 and one or multiple VASes and/or MCSes, among other operations. In one example, the remote computing devices 106c provide cloud servers for one or more SONOS Wireless HiFi Systems.

In various implementations, one or more of the playback devices 102 may take the form of or include an on-board (e.g., integrated) network microphone device. For example, the playback devices 102a-e include or are otherwise equipped with corresponding NMDs 103a-e, respectively. A playback device that includes or is equipped with an NMD may be referred to herein interchangeably as a playback device or an NMD unless indicated otherwise in the description. In some cases, one or more of the NMDs 103 may be a stand-alone device. For example, the NMDs 103f and 103g may be stand-alone devices. A stand-alone NMD may omit components and/or functionality that is typically included in a playback device, such as a speaker or related electronics. For instance, in such cases, a stand-alone NMD may not produce audio output or may produce limited audio output (e.g., relatively low-quality audio output).

The various play back and network microphone devices 102 and 103 of the MPS 100 may each be associated with a unique name, which may be assigned to the respective devices by a user, such as during setup of one or more of these devices. For instance, as shown in the illustrated example of FIG. 1B, a user may assign the name “Bookcase” to play back device 102d because it is physically situated on a bookcase. Similarly, the NMD 103f may be assigned the named “Island” because it is physically situated on an island countertop in the kitchen 101h (FIG. 1A). Some playback devices may be assigned names according to a zone or room, such as the playback devices 102e, 102l, 102m, and 102n, which are named “Bedroom,” “Dining Room,” “Living Room,” and “Office,” respectively. Further, certain playback devices may have functionally descriptive names. For example, the playback devices 102a and 102b are assigned the names “Right” and “Front,” respectively, because these two devices are configured to provide specific audio channels during media play back in the zone of the Den 101d (FIG. 1A). The playback device 102c in the Patio may be named portable because it is battery-powered and/or readily transportable to different areas of the environment 101. Other naming conventions are possible.

As discussed above, an NMD may detect and process sound from its environment, such as sound that includes background noise mixed with speech spoken by a person in the NMD's vicinity. For example, as sounds are detected by the NMD in the environment, the NMD may process the detected sound to determine if the sound includes speech that contains voice input intended for the NMD and ultimately a particular VAS. For example, the NMD may identify whether speech includes a wake word associated with a particular VAS.

In the illustrated example of FIG. 1B, the NMDs 103 are configured to interact with the VAS 190 over a network via the network 111 and the router 109. Interactions with the VAS 190 may be initiated, for example, when an NMD identifies in the detected sound a potential wake word. The identification causes a wake-word event, which in turn causes the NMD to begin transmitting detected-sound data to the VAS 190. In some implementations, the various local network devices 102-105 (FIG. 1A) and/or remote computing devices 106c of the MPS 100 may exchange various feedback, information, instructions, and/or related data with the remote computing devices associated with the selected VAS. Such exchanges may be related to or independent of transmitted messages containing voice inputs. In some embodiments, the remote computing device(s) and the MPS 100 may exchange data via communication paths as described herein and/or using a metadata exchange channel as described in U.S. application Ser. No. 15/438,749 filed Feb. 21, 2017, and titled “Voice Control of a Media Play back System,” which is herein incorporated by reference in its entirety.

Upon receiving the stream of sound data, the VAS 190 determines if there is voice input in the streamed data from the NMD, and if so the VAS 190 will also determine an underlying intent in the voice input. The VAS 190 may next transmit a response back to the MPS 100, which can include transmitting the response directly to the NMD that caused the wake-word event. The response is typically based on the intent that the VAS 190 determined was present in the voice input. As an example, in response to the VAS 190 receiving a voice input with an utterance to “Play Hey Jude by The Beatles,” the VAS 190 may determine that the underlying intent of the voice input is to initiate playback and further determine that intent of the voice input is to play the particular song “Hey Jude.” After these determinations, the VAS 190 may transmit a command to a particular MCS 192 to retrieve content (i.e., the song “Hey Jude”), and that MCS 192, in turn, provides (e.g., streams) this content directly to the MPS 100 or indirectly via the VAS 190. In some implementations, the VAS 190 may transmit to the MPS 100 a command that causes the MPS 100 itself to retrieve the content from the MCS 192.

In certain implementations, NMDs may facilitate arbitration amongst one another when voice input is identified in speech detected by two or more NMDs located within proximity of one another. For example, the NMD-equipped playback device 102d in the environment 101 (FIG. 1A) is in relatively close proximity to the NMD-equipped Living Room playback device 102m, and both devices 102d and 102m may at least sometimes detect the same sound. In such cases, this may require arbitration as to which device is ultimately responsible for providing detected-sound data to the remote VAS. Examples of arbitrating between NMDs may be found, for example, in previously referenced U.S. application Ser. No. 15/438,749.

In certain implementations, an NMD may be assigned to, or otherwise associated with, a designated or default playback device that may not include an NMD. For example, the Island NMD 103f in the kitchen 101h (FIG. 1A) may be assigned to the dining room playback device 102l, which is in relatively close proximity to the Island NMD 103f. In practice, an NMD may direct an assigned playback device to play audio in response to a remote VAS receiving a voice input from the NMD to play the audio, which the NMD might have sent to the VAS in response to a user speaking a command to play a certain song, album, playlist, etc. Additional details regarding assigning NMDs and playback devices as designated or default devices may be found, for example, in previously referenced U.S. Patent Application No.

Further aspects relating to the different components of the example MPS 100 and how the different components may interact to provide a user with a media experience may be found in the following sections. While discussions herein may generally refer to the example MPS 100, technologies described herein are not limited to applications within, among other things, the home environment described above. For instance, the technologies described herein may be useful in other home environment configurations comprising more or fewer of any of the play back, network microphone, and/or controller devices 102-104. For example, the technologies herein may be utilized within an environment having a single play back device 102 and/or a single NMD 103. In some examples of such cases, the NETWORK 111 (FIG. 1B) may be eliminated and the single play back device 102 and/or the single NMD 103 may communicate directly with the remote computing devices 106-d. In some embodiments, a telecommunication network (e.g., an LTE network, a 5G network, etc.) may communicate with the various playback, network microphone, and/or controller devices 102-104 independent of a LAN.

a. Example Playback & Network Microphone Devices

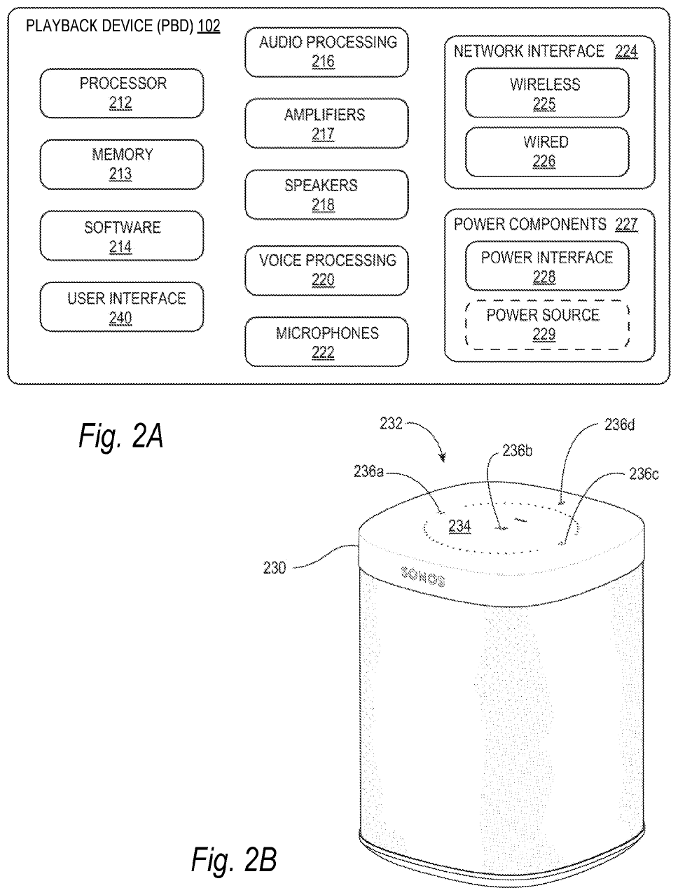

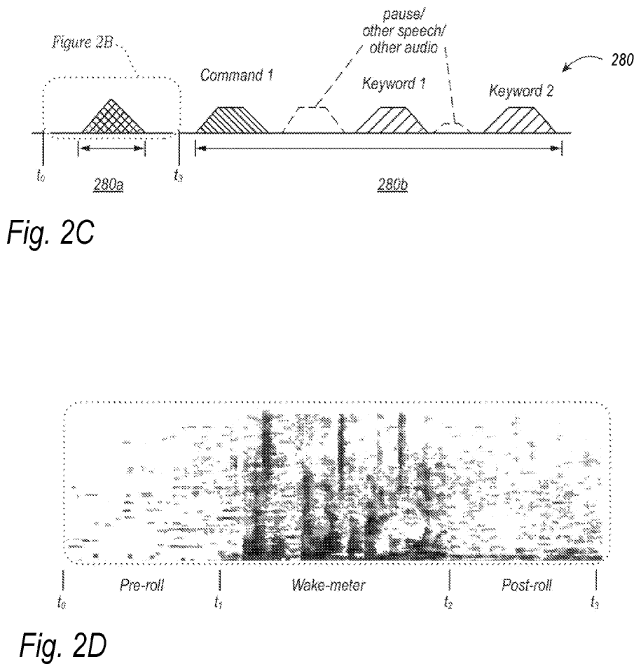

FIG. 2A is a functional block diagram illustrating certain aspects of one of the play back devices 102 of the MPS 100 of FIGS. 1A and 1B. As shown, the play back device 102 includes various components, each of which is discussed in further detail below, and the various components of the play back device 102 may be operably coupled to one another via a system bus, communication network, or some other connection mechanism. In the illustrated example of FIG. 2A, the play back device 102 may be referred to as an “NMD-equipped” playback device because it includes components that support the functionality of an NMD, such as one of the NMDs 103 shown in FIG. 1A.

As shown, the play back device 102 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the playback device 102 retrieving audio data from an audio source, which may be another playback device. In another example, the functions may involve the playback device 102 sending audio data, detected-sound data (e.g., corresponding to a voice input), and/or other information to another device on a network via at least one network interface 224. In yet another example, the functions may involve the play back device 102 causing one or more other play back devices to synchronously playback audio with the play back device 102. In yet a further example, the functions may involve the playback device 102 facilitating being paired or otherwise bonded with one or more other playback devices to create a multi-channel audio environment. Numerous other example functions are possible, some of which are discussed below.

As just mentioned, certain functions may involve the playback device 102 synchronizing playback of audio content with one or more other playback devices. During synchronous playback, a listener may not perceive time-delay differences between play back of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among play back devices.

To facilitate audio playback, the playback device 102 includes audio processing components 216 that are generally configured to process audio prior to the playback device 102 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for play back.

The produced audio signals may then be provided to one or more audio amplifiers 217 for amplification and play back through one or more speakers 218 operably coupled to the amplifiers 217. The audio amplifiers 217 may include components configured to amplify audio signals to a level for driving one or more of the speakers 218.

In another aspect, the software code 214 configures the playback device 102 to be operable in a plurality of non contemporary room sound modes. In each mode, the play back device 102 may adopt certain settings and/or configurations in accordance with the room sound mode. Further, the software code 214 may be configured to detect occurrence of various triggers corresponding to one of more of the room sounds, and responsively switch the first playback device from operating in one mode to operating in another mode. Further details related to the room sound modes are described in connection with section III below.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, a playback device may not include the speakers 218, but instead may include a speaker interface for connecting the play back device to external speakers. In certain embodiments, a playback device may include neither the speakers 218 nor the audio amplifiers 217, but instead may include an audio interface (not shown) for connecting the play back device to an external audio amplifier or audio-visual receiver.

In addition to producing audio signals for playback by the playback device 102, the audio processing components 216 may be configured to process audio to be sent to one or more other playback devices, via the network interface 224, for playback. In example scenarios, audio content to be processed and/or played back by the playback device 102 may be received from an external source, such as via an audio line-in interface (e.g., an auto-detecting 3.5 mm audio line-in connection) of the playback device 102 (not shown) or via the network interface 224, as described below.

As shown, the at least one network interface 224, may take the form of one or more wireless interfaces 225 and/or one or more wired interfaces 226. A wireless interface may provide network interface functions for the playback device 102 to wirelessly communicate with other devices (e.g., other playback device(s), NMD(s), and/or controller device(s)) in accordance with a communication protocol (e.g., any wireless standard including IEEE 802.11a, 802.11b, 802.11g. 802.11n, 802.11ac, 802.15, 4G mobile communication standard, and so on). A wired interface may provide network interface functions for the playback device 102 to communicate over a wired connection with other devices in accordance with a communication protocol (e.g., IEEE 802.3). While the network interface 224 shown in FIG. 2A include both wired and wireless interfaces, the playback device 102 may in some implementations include only wireless interface(s) or only wired interface(s).

In general, the network interface 224 facilitates data flow between the playback device 102 and one or more other devices on a data network. For instance, the playback device 102 may be configured to receive audio content over the data network from one or more other play back devices, network devices within a LAN, and/or audio content sources over a WAN, such as the Internet. In one example, the audio content and other signals transmitted and received by the playback device 102 may be transmitted in the form of digital packet data comprising an Internet Protocol (IP)-based source address and IP-based destination addresses. In such a case, the network interface 224 may be configured to parse the digital packet data such that the data destined for the play back device 102 is properly received and processed by the play back device 102.

As shown in FIG. 2A, the playback device 102 also includes voice processing components 220 that are operably coupled to one or more microphones 222. The microphones 222 are configured to detect sound (i.e., acoustic waves) in the environment of the play back device 102, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the playback device 102 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a VAS, such as the VAS 190 (FIG. 1B), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2A, the playback device 102 also includes power components 227. The power components 227 include at least an external power source interface 228, which may be coupled to a power source (not shown) via a power cable or the like that physically connects the play back device 102 to an electrical outlet or some other external power source. Other power components may include, for example, transformers, converters, and like components configured to format electrical power.

In some implementations, the power components 227 of the playback device 102 may additionally include an internal power source 229 (e.g., one or more batteries) configured to power the playback device 102 without a physical connection to an external power source. When equipped with the internal power source 229, the playback device 102 may operate independent of an external power source. In some such implementations, the external power source interface 228 may be configured to facilitate charging the internal power source 229. As discussed before, a playback device comprising an internal power source may be referred to herein as a “portable playback device.” On the other hand, a playback device that operates using an external power source may be referred to herein as a “stationary playback device,” although such a device may in fact be moved around a home or other environment.

The play back device 102 further includes a user interface 240 that may facilitate user interactions independent of or in conjunction with user interactions facilitated by one or more of the controller devices 104. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

As an illustrative example, FIG. 2B shows an example housing 230 of the play back device 102 that includes a user interface in the form of a control area 232 at a top portion 234 of the housing 230. The control area 232 includes buttons 236a-c for controlling audio playback, volume level, and other functions. The control area 232 also includes a button 236d for toggling the microphones 222 to either an on state or an off state.

As further shown in FIG. 2B, the control area 232 is at least partially surrounded by apertures formed in the top portion 234 of the housing 230 through which the microphones 222 (not visible in FIG. 2B) receive the sound in the environment of the playback device 102. The microphones 222 may be arranged in various positions along and/or within the top portion 234 or other areas of the housing 230 so as to detect sound from one or more directions relative to the play back device 102.

By way of illustration, SONOS, Inc. presently offers (or has offered) for sale certain playback devices that may implement certain of the embodiments disclosed herein, including a “PLAY: 1.” “PLAY: 3.” “PLAY: 5.” “PLAYBAR,” “CONNECT:AMP.” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the examples illustrated in FIG. 2A or 2B or to the SONOS product offerings. For example, a playback device may include, or otherwise take the form of, a wired or wireless headphone set, which may operate as a part of the MPS 100 via a network interface or the like. In another example, a playback device may include or interact with a docking station for personal mobile media play back devices. In yet another example, a playback device may be integral to another device or component such as a television, a lighting fixture, or some other device for indoor or outdoor use.

FIG. 2C is a diagram of an example voice input 280 that may be processed by an NMD or an NMD-equipped playback device. The voice input 280 may include a keyword portion 280a and an utterance portion 280b. The keyword portion 280a may include a wake word or a command keyword. In the case of a wake word, the keyword portion 280a corresponds to detected sound that caused a wake-word The utterance portion 280b corresponds to detected sound that potentially comprises a user request following the keyword portion 280a. An utterance portion 280b can be processed to identify the presence of any words in detected-sound data by the NMD in response to the event caused by the keyword portion 280a. In various implementations, an underlying intent can be determined based on the words in the utterance portion 280b. In certain implementations, an underlying intent can also be based or at least partially based on certain words in the keyword portion 280a, such as when keyword portion includes a command keyword. In any case, the words may correspond to one or more commands, as well as a certain command and certain keywords. A keyword in the voice utterance portion 280b may be, for example, a word identifying a particular device or group in the MPS 100. For instance, in the illustrated example, the keywords in the voice utterance portion 280b may be one or more words identifying one or more zones in which the music is to be played, such as the Living Room and the Dining Room (FIG. 1A). In some cases, the utterance portion 280b may include additional information, such as detected pauses (e.g., periods of non-speech) between words spoken by a user, as shown in FIG. 2C. The pauses may demarcate the locations of separate commands, keywords, or other information spoke by the user within the utterance portion 280b.

Based on certain command criteria, the NMD and/or a remote VAS may take actions as a result of identifying one or more commands in the voice input. Command criteria may be based on the inclusion of certain keywords within the voice input, among other possibilities. Additionally, or alternatively, command criteria for commands may involve identification of one or more control-state and/or zone-state variables in conjunction with identification of one or more particular commands. Control-state variables may include, for example, indicators identifying a level of volume, a queue associated with one or more devices, and play back state, such as whether devices are playing a queue, paused, etc. Zone-state variables may include, for example, indicators identifying which, if any, zone players are grouped.

In some implementations, the MPS 100 is configured to temporarily reduce the volume of audio content that it is playing upon detecting a certain keyword, such as a wake word, in the keyword portion 280a. The MPS 100 may restore the volume after processing the voice input 280. Such a process can be referred to as ducking, examples of which are disclosed in U.S. patent application Ser. No. 15/438,749, incorporated by reference herein in its entirety.

FIG. 2D shows an example sound specimen. In this example, the sound specimen corresponds to the sound-data stream (e.g., one or more audio frames) associated with a spotted wake word or command keyword in the keyword portion 280a of FIG. 2A. As illustrated, the example sound specimen comprises sound detected in an NMD's environment (i) immediately before a wake or command word was spoken, which may be referred to as a pre-roll portion (between times to and t₁), (ii) while a wake or command word was spoken, which may be referred to as a wake-meter portion (between times t₁ and t₂), and/or (iii) after the wake or command word was spoken, which may be referred to as a post-roll portion (between times t₂ and t₃). Other sound specimens are also possible. In various implementations, aspects of the sound specimen can be evaluated according to an acoustic model which aims to map mels/spectral features to phonemes in a given language model for further processing. For example, automatic speech recognition (ASR) may include such mapping for command-keyword detection. Wake-word detection engines, by contrast, may be precisely tuned to identify a specific wake-word, and a downstream action of invoking a VAS (e.g., by targeting only nonce words in the voice input processed by the play back device).

ASR for command keyword detection may be tuned to accommodate a wide range of keywords (e.g., 5, 10, 100, 1,000, 10,000 keywords). Command keyword detection, in contrast to wake-word detection, may involve feeding ASR output to an onboard, local NLU which together with the ASR determine when command word events have occurred. In some implementations described below; the local NLU may determine an intent based on one or more other keywords in the ASR output produced by a particular voice input. In these or other implementations, a playback device may act on a detected command keyword event only when the playback devices determines that certain conditions have been met, such as environmental conditions (e.g., low background noise).

The play back device 102 may further include a voice activity detector (VAD), which may be implemented as part of the voice processing components 220. The VAD is configured to detect the presence (or lack thereof) of voice activity in the sound-data stream from the microphones 222. In particular, the VAD may analyze frames corresponding to the pre-roll portion of the voice input 280a (FIG. 2D) with one or more voice detection algorithms to determine whether voice activity was present in the environment in certain time windows prior to a keyword portion of the voice input 280a.

The VAD may utilize any suitable voice activity detection algorithms. Example voice detection algorithms involve determining whether a given frame includes one or more features or qualities that correspond to voice activity, and further determining whether those features or qualities diverge from noise to a given extent (e.g., if a value exceeds a threshold for a given frame). Some example voice detection algorithms involve filtering or otherwise reducing noise in the frames prior to identifying the features or qualities.

In some examples, the VAD may determine whether voice activity is present in the environment based on one or more metrics. For example, the VAD can be configured to distinguish between frames that include voice activity and frames that don't include voice activity. The frames that the VAD determines have voice activity may be caused by speech regardless of whether it near- or far-field. In this example and others, the VAD may determine a count of frames in the voice input 280a that indicate voice activity. If this count exceeds a threshold percentage or number of frames, the VAD may be configured to output a signal or set a state variable indicating that voice activity is present in the environment. Other metrics may be used as well in addition to, or as an alternative to, such a count.

When the VAD detects voice activity in an environment, the VAD may set a state variable in the playback device indicating that voice activity is present. Conversely, when the VAD does not voice activity in an environment, the VAD may set the state variable in the play back device to indicate that voice activity is not present. Changing the state of this state variable may function as a mode trigger condition in some examples.

b. Example Playback Device Configurations

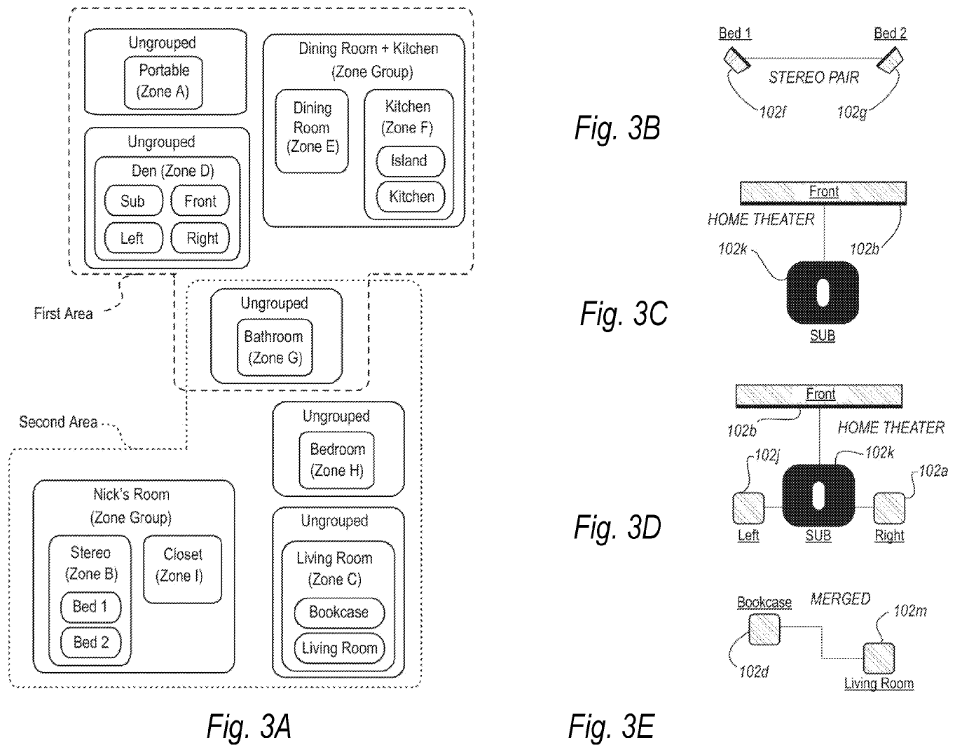

FIGS. 3A-3E show example configurations of play back devices. Referring first to FIG. 3A, in some example instances, a single playback device may belong to a zone. For example, the playback device 102c (FIG. 1A) on the Patio may belong to Zone A. In some implementations described below, multiple playback devices may be “bonded” to form a “bonded pair,” which together form a single zone. For example, the playback device 102f (FIG. 1A) named “Bed 1” in FIG. 3A may be bonded to the play back device 102g (FIG. 1A) named “Bed 2” in FIG. 3A to form Zone B. Bonded playback devices may have different playback responsibilities (e.g., channel responsibilities). In another implementation described below; multiple play back devices may be merged to form a single zone. For example, the play back device 102d named “Bookcase” may be merged with the playback device 102m named “Living Room” to form a single Zone C. The merged playback devices 102d and 102m may not be specifically assigned different playback responsibilities. That is, the merged play back devices 102d and 102m may, aside from playing audio content in synchrony, each play audio content as they would if they were not merged.

For purposes of control, each zone in the MPS 100 may be represented as a single user interface (“UI”) entity. For example, as displayed by the controller devices 104, Zone A may be provided as a single entity named “Portable,” Zone B may be provided as a single entity named “Stereo,” and Zone C may be provided as a single entity named “Living Room.”

In various embodiments, a zone may take on the name of one of the play back devices belonging to the zone. For example, Zone C may take on the name of the Living Room device 102m (as shown). In another example, Zone C may instead take on the name of the Bookcase device 102d. In a further example, Zone C may take on a name that is some combination of the Bookcase device 102d and Living Room device 102m. The name that is chosen may be selected by a user via inputs at a controller device 104. In some embodiments, a zone may be given a name that is different than the device(s) belonging to the zone. For example, Zone B in FIG. 3A is named “Stereo” but none of the devices in Zone B have this name. In one aspect, Zone B is a single UI entity representing a single device named “Stereo,” composed of constituent devices “Bed 1” and “Bed 2.” In one implementation, the Bed 1 device may be playback device 102f in the master bedroom 101b (FIG. 1A) and the Bed 2 device may be the playback device 102g also in the master bedroom 101b (FIG. 1A).

As noted above, playback devices that are bonded may have different playback responsibilities, such as playback responsibilities for certain audio channels. For example, as shown in FIG. 3B, the Bed 1 and Bed 2 devices 102f and 102g may be bonded so as to produce or enhance a stereo effect of audio content. In this example, the Bed 1 playback device 102f may be configured to play a left channel audio component, while the Bed 2 play back device 102g may be configured to play a right channel audio component. In some implementations, such stereo bonding may be referred to as “pairing.”

Additionally, playback devices that are configured to be bonded may have additional and/or different respective speaker drivers. As shown in FIG. 3C, the playback device 102b named “Front” may be bonded with the playback device 102k named “SUB.” The Front device 102b may render a range of mid to high frequencies, and the SUB device 102k may render low frequencies as, for example, a subwoofer. When unbonded, the Front device 102b may be configured to render a full range of frequencies. As another example, FIG. 3D shows the Front and SUB devices 102b and 102k further bonded with Right and Left playback devices 102a and 102j, respectively. In some implementations, the Right and Left devices 102a and 102j may form surround or “satellite” channels of a home theater system. The bonded playback devices 102a, 102b, 102j, and 102k may form a single Zone D (FIG. 3A).

In some implementations, playback devices may also be “merged.” In contrast to certain bonded playback devices, playback devices that are merged may not have assigned play back responsibilities, but may each render the full range of audio content that each respective play back device is capable of. Nevertheless, merged devices may be represented as a single UI entity (i.e., a zone, as discussed above). For instance, FIG. 3E shows the playback devices 102d and 102m in the Living Room merged, which would result in these devices being represented by the single UI entity of Zone C. In one embodiment, the play back devices 102d and 102m may playback audio in synchrony, during which each outputs the full range of audio content that each respective playback device 102d and 102m is capable of rendering.

In some embodiments, a stand-alone NMD may be in a zone by itself. For example, the NMD 103h from FIG. 1A is named “Closet” and forms Zone 1 in FIG. 3A. An NMD may also be bonded or merged with another device so as to form a zone. For example, the NMD device 103f named “Island” may be bonded with the play back device 102i Kitchen, which together form Zone F, which is also named “Kitchen.” Additional details regarding assigning NMDs and playback devices as designated or default devices may be found, for example, in previously referenced U.S. patent application Ser. No. 15/438,749. In some embodiments, a stand-alone NMD may not be assigned to a zone.

Zones of individual, bonded, and/or merged devices may be arranged to form a set of playback devices that playback audio in synchrony. Such a set of play back devices may be referred to as a “group,” “zone group,” “synchrony group,” or “play back group.” In response to inputs provided via a controller device 104, playback devices may be dynamically grouped and ungrouped to form new or different groups that synchronously play back audio content. For example, referring to FIG. 3A, Zone A may be grouped with Zone B to form a zone group that includes the play back devices of the two zones. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Grouped and bonded devices are example types of associations between portable and stationary playback devices that may be caused in response to a trigger event, as discussed above and described in greater detail below:

In various implementations, the zones in an environment may be assigned a particular name, which may be the default name of a zone within a zone group or a combination of the names of the zones within a zone group, such as “Dining Room+Kitchen,” as shown in FIG. 3A. In some embodiments, a zone group may be given a unique name selected by a user, such as “Nick's Room,” as also shown in FIG. 3A. The name “Nick's Room” may be a name chosen by a user over a prior name for the zone group, such as the room name “Master Bedroom.”

Referring back to FIG. 2A, certain data may be stored in the memory 213 as one or more state variables that are periodically updated and used to describe the state of a playback zone, the play back device(s), and/or a zone group associated therewith. The memory 213 may also include the data associated with the state of the other devices of the MPS 100, which may be shared from time to time among the devices so that one or more of the devices have the most recent data associated with the system.

In some embodiments, the memory 213 of the playback device 102 may store instances of various variable types associated with the states. Variables instances may be stored with identifiers (e.g., tags) corresponding to type. For example, certain identifiers may be a first type “a1” to identify playback device(s) of a zone, a second type “b1” to identify play back device(s) that may be bonded in the zone, and a third type “c1” to identify a zone group to which the zone may belong. As a related example, in FIG. 1A, identifiers associated with the Patio may indicate that the Patio is the only play back device of a particular zone and not in a zone group. Identifiers associated with the Living Room may indicate that the Living Room is not grouped with other zones but includes bonded playback devices 102a, 102b, 102j, and 102k. Identifiers associated with the Dining Room may indicate that the Dining Room is part of Dining Room+Kitchen group and that devices 103f and 102i are bonded. Identifiers associated with the Kitchen may indicate the same or similar information by virtue of the Kitchen being part of the Dining Room+Kitchen zone group. Other example zone variables and identifiers are described below.

In yet another example, the MPS 100 may include variables or identifiers representing other associations of zones and zone groups, such as identifiers associated with Areas, as shown in FIG. 3A. An Area may involve a cluster of zone groups and/or zones not within a zone group. For instance, FIG. 3A shows a first area named “First Area” and a second area named “Second Area.” The First Area includes zones and zone groups of the Patio, Den, Dining Room, Kitchen, and Bathroom. The Second Area includes zones and zone groups of the Bathroom, Nick's Room, Bedroom, and Living Room. In one aspect, an Area may be used to invoke a cluster of zone groups and/or zones that share one or more zones and/or zone groups of another cluster. In this respect, such an Area differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety.

The memory 213 may be further configured to store other data. Such data may pertain to audio sources accessible by the playback device 102 or a playback queue that the playback device (or some other playback device(s)) may be associated with. In embodiments described below; the memory 213 is configured to store a set of command data for selecting a particular VAS when processing voice inputs. During operation, one or more playback zones in the environment of FIG. 1A may each be playing different audio content. For instance, the user may be grilling in the Patio zone and listening to hip hop music being played by the playback device 102c, while another user may be preparing food in the Kitchen zone and listening to classical music being played by the play back device 102i. In another example, a playback zone may play the same audio content in synchrony with another playback zone.

For instance, the user may be in the Office zone where the playback device 102n is playing the same hip-hop music that is being playing by playback device 102c in the Patio zone. In such a case, playback devices 102c and 102n may be playing the hip-hop in synchrony such that the user may seamlessly (or at least substantially seamlessly) enjoy the audio content that is being played out-loud while moving between different playback zones. Synchronization among playback zones may be achieved in a manner similar to that of synchronization among play back devices, as described in previously referenced U.S. Pat. No. 8,234,395.

As suggested above, the zone configurations of the MPS 100 may be dynamically modified. As such, the MPS 100 may support numerous configurations. For example, if a user physically moves one or more playback devices to or from a zone, the MPS 100 may be reconfigured to accommodate the change(s). For instance, if the user physically moves the playback device 102c from the Patio zone to the Office zone, the Office zone may now include both the playback devices 102c and 102n. In some cases, the user may pair or group the moved play back device 102c with the Office zone and/or rename the players in the Office zone using, for example, one of the controller devices 104 and/or voice input. As another example, if one or more play back devices 102 are moved to a particular space in the home environment that is not already a playback zone, the moved playback device(s) may be renamed or associated with a play back zone for the particular space.

Further, different play back zones of the MPS 100 may be dynamically combined into zone groups or split up into individual playback zones. For example, the Dining Room zone and the Kitchen zone may be combined into a zone group for a dinner party such that playback devices 102i and 102l may render audio content in synchrony. As another example, bonded playback devices in the Den zone may be split into (i) a television zone and (ii) a separate listening zone. The television zone may include the Front playback device 102b. The listening zone may include the Right, Left, and SUB playback devices 102a, 102j, and 102k, which may be grouped, paired, or merged, as described above. Splitting the Den zone in such a manner may allow one user to listen to music in the listening zone in one area of the living room space, and another user to watch the television in another area of the living room space. In a related example, a user may utilize either of the NMD 103a or 103b (FIG. 1B) to control the Den zone before it is separated into the television zone and the listening zone. Once separated, the listening zone may be controlled, for example, by a user in the vicinity of the NMD 103a, and the television zone may be controlled, for example, by a user in the vicinity of the NMD 103b. As described above, however, any of the NMDs 103 may be configured to control the various play back and other devices of the MPS 100.

c. Example Controller Devices

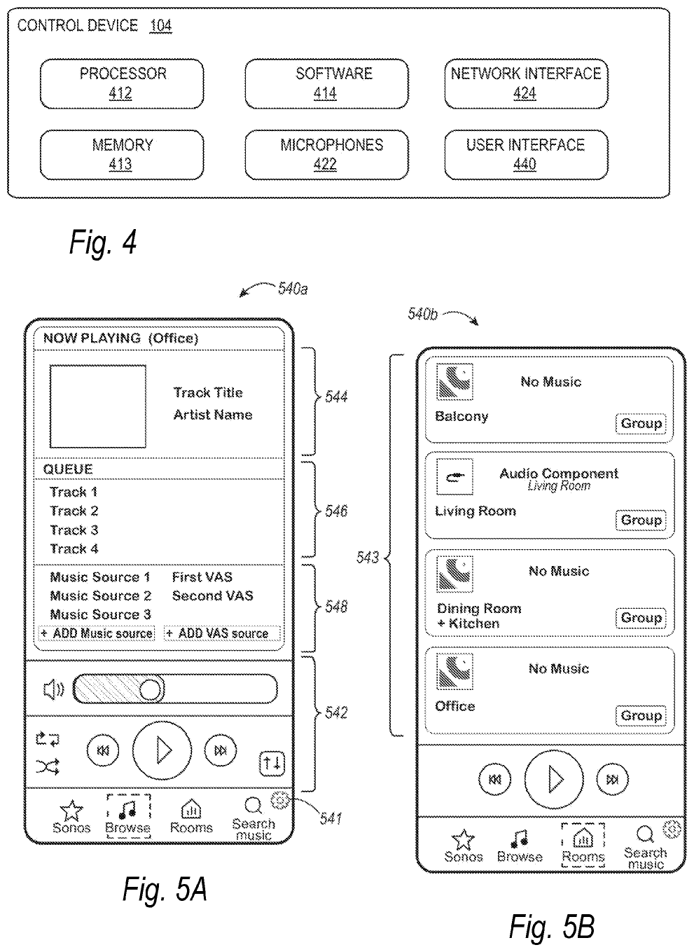

FIG. 4 is a functional block diagram illustrating certain aspects of a selected one of the controller devices 104 of the MPS 100 of FIG. 1A. Such controller devices may also be referred to herein as a “control device” or “controller.” The controller device shown in FIG. 4 may include components that are generally similar to certain components of the network devices described above, such as a processor 412, memory 413 storing program software 414, at least one network interface 424, and one or more microphones 422. In one example, a controller device may be a dedicated controller for the MPS 100. In another example, a controller device may be a network device on which media play back system controller application software may be installed, such as for example, an iPhone™, iPad™ or any other smart phone, tablet, or network device (e.g., a networked computer such as a PC or Mac™).

The memory 413 of the controller device 104 may be configured to store controller application software and other data associated with the MPS 100 and/or a user of the system 100. The memory 413 may be loaded with instructions in software 414 that are executable by the processor 412 to achieve certain functions, such as facilitating user access, control, and/or configuration of the MPS 100. The controller device 104 is configured to communicate with other network devices via the network interface 424, which may take the form of a wireless interface, as described above.

In one example, system information (e.g., such as a state variable) may be communicated between the controller device 104 and other devices via the network interface 424. For instance, the controller device 104 may receive playback zone and zone group configurations in the MPS 100 from a playback device, an NMD, or another network device. Likewise, the controller device 104 may transmit such system information to a playback device or another network device via the network interface 424. In some cases, the other network device may be another controller device.

The controller device 104 may also communicate playback device control commands, such as volume control and audio playback control, to a playback device via the network interface 424. As suggested above, changes to configurations of the MPS 100 may also be performed by a user using the controller device 104. The configuration changes may include adding/removing one or more playback devices to/from a zone, adding/removing one or more zones to/from a zone group, forming a bonded or merged player, separating one or more play back devices from a bonded or merged player, among others.

As shown in FIG. 4, the controller device 104 also includes a user interface 440 that is generally configured to facilitate user access and control of the MPS 100. The user interface 440 may include a touch-screen display or other physical interface configured to provide various graphical controller interfaces, such as the controller interfaces 540a and 540b shown in FIGS. 5A and 5B. Referring to FIGS. 5A and 5B together, the controller interfaces 540a and 540b includes a play back control region 542, a play back zone region 543, a play back status region 544, a play back queue region 546, and a sources region 548. The user interface as shown is just one example of an interface that may be provided on a network device, such as the controller device shown in FIG. 4, and accessed by users to control a media play back system, such as the MPS 100. Other user interfaces of varying formats, styles, and interactive sequences may alternatively be implemented on one or more network devices to provide comparable control access to a media play back system.

The play back control region 542 (FIG. 5A) may include selectable icons (e.g., by way of touch or by using a cursor) that, when selected, cause playback devices in a selected play back zone or zone group to play or pause, fast forward, rewind, skip to next, skip to previous, enter/exit shuffle mode, enter/exit repeat mode, enter/exit cross fade mode, etc. The play back control region 542 may also include selectable icons that, when selected, modify equalization settings and/or play back volume, among other possibilities.

The playback zone region 543 (FIG. 5B) may include representations of play back zones within the MPS 100. The playback zones regions 543 may also include a representation of zone groups, such as the Dining Room+Kitchen zone group, as shown.

In some embodiments, the graphical representations of playback zones may be selectable to bring up additional selectable icons to manage or configure the play back zones in the MPS 100, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the MPS 100 to be grouped with the particular zone. Once grouped, playback devices in the zones that have been grouped with the particular zone will be configured to play audio content in synchrony with the play back device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface are also possible. The representations of playback zones in the playback zone region 543 (FIG. 5B) may be dynamically updated as playback zone or zone group configurations are modified.

The playback status region 544 (FIG. 5A) may include graphical representations of audio content that is presently being played, previously played, or scheduled to play next in the selected playback zone or zone group. The selected playback zone or zone group may be visually distinguished on a controller interface, such as within the playback zone region 543 and/or the playback status region 544. The graphical representations may include track title, artist name, album name, album year, track length, and/or other relevant information that may be useful for the user to know when controlling the MPS 100 via a controller interface.

The playback queue region 546 may include graphical representations of audio content in a playback queue associated with the selected playback zone or zone group. In some embodiments, each playback zone or zone group may be associated with a playback queue comprising information corresponding to zero or more audio items for playback by the play back zone or zone group. For instance, each audio item in the playback queue may comprise a uniform resource identifier (URI), a uniform resource locator (URL), or some other identifier that may be used by a playback device in the playback zone or zone group to find and/or retrieve the audio item from a local audio content source or a networked audio content source, which may then be played back by the play back device.

In one example, a playlist may be added to a playback queue, in which case information corresponding to each audio item in the playlist may be added to the playback queue. In another example, audio items in a playback queue may be saved as a playlist. In a further example, a play back queue may be empty, or populated but “not in use” when the play back zone or zone group is playing continuously streamed audio content, such as Internet radio that may continue to play until otherwise stopped, rather than discrete audio items that have play back durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped.” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first play back queue (such as if the second playback zone was added to the first playback zone), that contains audio items from the second playback queue (such as if the first play back zone was added to the second playback zone), or a combination of audio items from both the first and second playback queues. Subsequently, if the established zone group is ungrouped, the resulting first playback zone may be re-associated with the previous first playback queue or may be associated with a new playback queue that is empty or contains audio items from the playback queue associated with the established zone group before the established zone group was ungrouped. Similarly, the resulting second playback zone may be re-associated with the previous second playback queue or may be associated with a new playback queue that is empty or contains audio items from the play back queue associated with the established zone group before the established zone group was ungrouped. Other examples are also possible.

With reference still to FIGS. 5A and 5B, the graphical representations of audio content in the play back queue region 646 (FIG. 5A) may include track titles, artist names, track lengths, and/or other relevant information associated with the audio content in the play back queue. In one example, graphical representations of audio content may be selectable to bring up additional selectable icons to manage and/or manipulate the play back queue and/or audio content represented in the playback queue. For instance, a represented audio content may be removed from the play back queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device. Playback of such a playback queue may involve one or more play back devices playing back media items of the queue, perhaps in sequential or random order.

The sources region 548 may include graphical representations of selectable audio content sources and/or selectable voice assistants associated with a corresponding VAS. The VASes may be selectively assigned. In some examples, multiple VASes, such as AMAZON's Alexa, MICROSOFT's Cortana, etc., may be invokable by the same NMD. In some embodiments, a user may assign a VAS exclusively to one or more NMDs. For example, a user may assign a first VAS to one or both of the NMDs 102a and 102b in the Living Room shown in FIG. 1A, and a second VAS to the NMD 103f in the Kitchen. Other examples are possible.

d. Example Audio Content Sources

The audio sources in the sources region 548 may be audio content sources from which audio content may be retrieved and played by the selected play back zone or zone group. One or more playback devices in a zone or zone group may be configured to retrieve for play back audio content (e.g., according to a corresponding URI or URL for the audio content) from a variety of available audio content sources. In one example, audio content may be retrieved by a play back device directly from a corresponding audio content source (e.g., via a line-in connection). In another example, audio content may be provided to a play back device over a network via one or more other playback devices or network devices. As described in greater detail below; in some embodiments audio content may be provided by one or more media content services.

Example audio content sources may include a memory of one or more playback devices in a media play back system such as the MPS 100 of FIG. 1, local music libraries on one or more network devices (e.g., a controller device, a network-enabled personal computer, or a networked-attached storage (“NAS”)), streaming audio services providing audio content via the Internet (e.g., cloud-based music services), or audio sources connected to the media playback system via a line-in input connection on a playback device or network device, among other possibilities.

In some embodiments, audio content sources may be added or removed from a media play back system such as the MPS 100 of FIG. 1A. In one example, an indexing of audio items may be performed whenever one or more audio content sources are added, removed, or updated. Indexing of audio items may involve scanning for identifiable audio items in all folders/directories shared over a network accessible by playback devices in the media playback system and generating or updating an audio content database comprising metadata (e.g., title, artist, album, track length, among others) and other associated information, such as a URI or URL for each identifiable audio item found. Other examples for managing and maintaining audio content sources may also be possible.

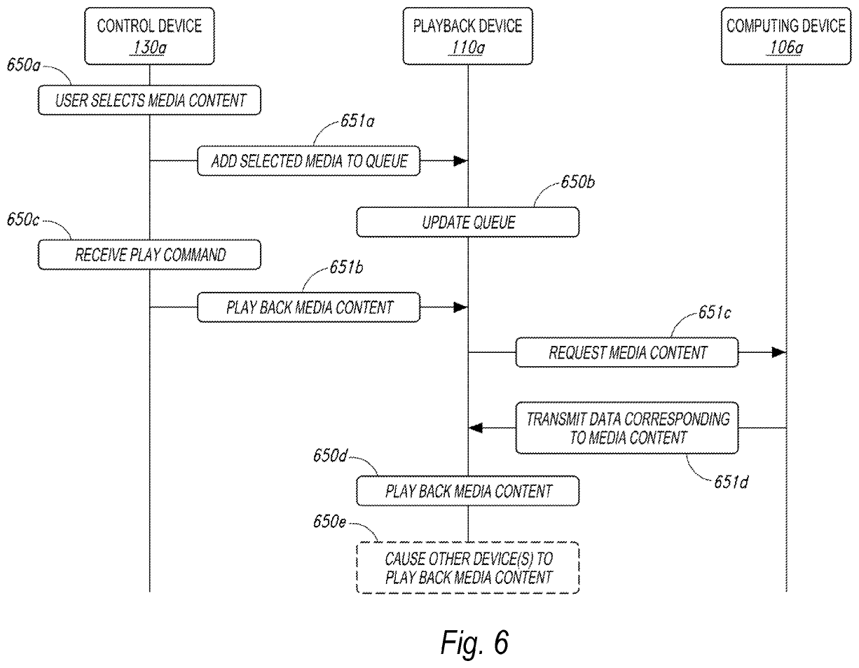

FIG. 6 is a message flow diagram illustrating data exchanges between devices of the MPS 100. At step 650a, the MPS 100 receives an indication of selected media content (e.g., one or more songs, albums, playlists, podcasts, videos, stations) via the control device 104. The selected media content can comprise, for example, media items stored locally on or more devices (e.g., the audio source 105 of FIG. 1C) connected to the media playback system and/or media items stored on one or more media service servers (one or more of the remote computing devices 106 of FIG. 1B). In response to receiving the indication of the selected media content, the control device 104 transmits a message 651a to the playback device 102 (FIGS. 1A-1C) to add the selected media content to a play back queue on the playback device 102.

At step 650b, the playback device 102 receives the message 651a and adds the selected media content to the playback queue for play back.

At step 650c, the control device 104 receives input corresponding to a command to play back the selected media content. In response to receiving the input corresponding to the command to play back the selected media content, the control device 104 transmits a message 651b to the play back device 102 causing the playback device 102 to play back the selected media content. In response to receiving the message 651b, the playback device 102 transmits a message 651c to the computing device 106 requesting the selected media content. The computing device 106, in response to receiving the message 651c, transmits a message 651d comprising data (e.g., audio data, video data, a URL, a URI) corresponding to the requested media content.

At step 650d, the playback device 102 receives the message 651d with the data corresponding to the requested media content and plays back the associated media content.

At step 650e, the play back device 102 optionally causes one or more other devices to play back the selected media content. In one example, the playback device 102 is one of a bonded zone of two or more players (FIG. 1M). The playback device 102 can receive the selected media content and transmit all or a portion of the media content to other devices in the bonded zone. In another example, the playback device 102 is a coordinator of a group and is configured to transmit and receive timing information from one or more other devices in the group. The other one or more devices in the group can receive the selected media content from the computing device 106, and begin play back of the selected media content in response to a message from the play back device 102 such that all of the devices in the group play back the selected media content in synchrony.

Within examples, such messages may conform to one or more protocols or interfaces (e.g., an Application Programming Interface). A platform API may support one or more namespaces that include controllable resources (e.g., the playback devices 102 and features thereof). Various functions may modify the resources and thereby control actions on the play back devices 102. For instance, HTTP request methods such as GET and POST may request and modify various resources in a namespace. Example namespaces in a platform API include playback (including controllable resources for playback), playbackMetadata (including metadata resources related to playback), volume (including resources for volume control), playlist (including resources for queue management), and groupVolume (including resources for volume control of a synchrony group), among other examples. Among other examples, such messages may conform to a standard, such as universal-plug-and-play (uPnP).

### III. Example Edge Caching in a Media Playback System

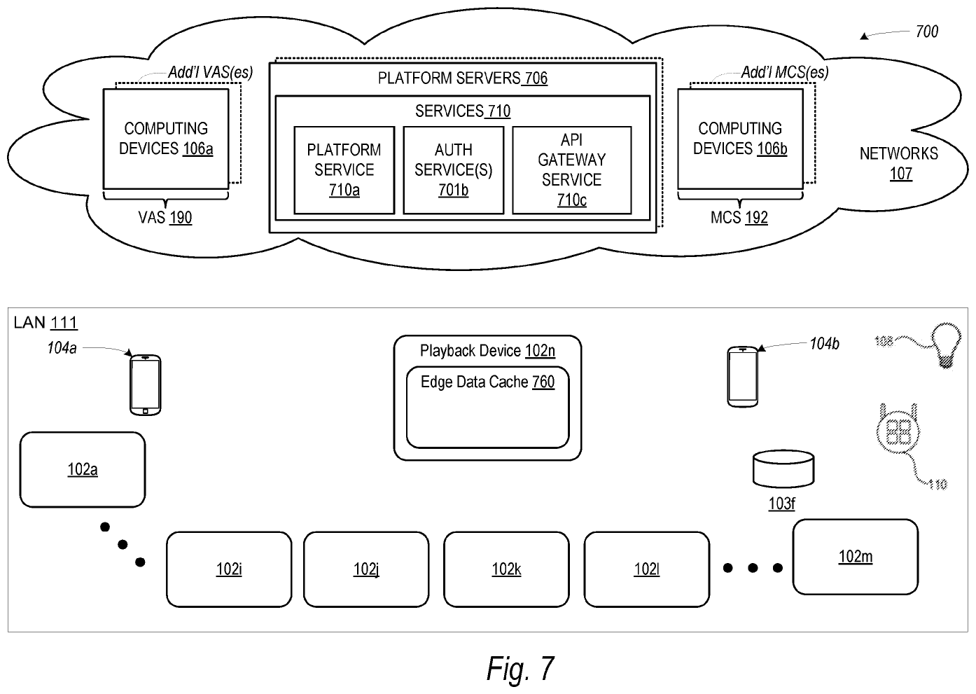

Example techniques described herein relate to edge caching in a media play back system, such as the media playback system 100 illustrated in FIGS. 1A and 1B. FIG. 7 is a functional block diagram illustrating an example architecture 700 in which edge caching may be performed. The architecture 700 and its constituent devices is provided for purposes of illustration only, and other implementations may include different combinations of devices.

Shown in FIG. 7 are one or more platform servers 706. The platform servers 706 may provide one or more services 710 that support the media playback system 100. In providing cloud-based services, the one or more platform servers 706 may operate as a cloud-based hub for a plurality of media play back systems 100 (e.g., with unique household identifiers, which may be registered to different users and/or located in different households), as well as other types of “smart home” systems and platforms. Within examples, the platform servers 706 may be self-hosted, or hosted using a cloud service provider (e.g., Amazon Web Services®), or may be representative of third-party computing systems that provide cloud services.

The platform servers 706 are located in the “cloud.” That is, they are not on the LAN 111 and are instead connected to the networks 107 (FIG. 1B). Other computing systems in the cloud include the computing devices 106a (which provide the voice assistant service 190) (FIG. 1B) and also the computing devices 106b (which provide the MCS 192).

By way of example, the services 710 may include a platform service 710a. The platform service is configured to support and/or enhance the media play back system 100 by leveraging cloud computing resources. In one aspect, the platform service 710a hosts data generated and used in operation of the media play back system 100.

As noted in the foregoing sections, the media playback system 100 may generate, maintain, and use a variety of state information during operation. As noted above, this state information may be organized into one or more namespaces that include controllable resources (e.g., the playback devices 102 and features thereof). By setting the values of the various resources, entities may control the operation of the media play back system 100 and its constituent devices. Certain state information may apply to an individual playback device 102, a group, or the media play back system 100 as a whole.

An individual playback device 102 may maintain state information describing its own state, which governs operation of the playback device 102. This state information may include topology data indicating the household, zone, zone group, and/or areas that the playback device 102 belongs to, as discussed above in section II. b. The topology data may also include indicate what is currently playing (or last played), whether the player is active, and/or what is in the player's queue, as well as volume data indicating the current volume level. In aggregate, the topology date for the play back devices 102 in the media play back system 100 may be referred to as system topology data or information.

When two or more playback devices 102 are in a group, certain state information may be the same for the members of the group. For instance, as a result of being in a group, the grouped playback devices 102 may have the same or similar topology information indicating the household and zone group that the grouped players belong to, as well as similar playback data indicating what is currently playing (or last played), whether the player is active, and/or what is in the player's queue). Some state information may be different among the grouped play back devices 102, such as different individual volume levels.

Other state information applies on a system-wide level. For instance, the state information may include service data representing user accounts of content services (e.g., streaming audio services) and/or voice assistant services that are registered with the media play back system 100. Other system-wide state information may include system settings.

Some state information may be based on the individual user. The media play back system 100 may maintain user profiles corresponding to one or more users. Each user profile may include personalization data such as user favorites, playback history, and custom playlists, among other examples. Such data may be used to customize user experience on the control devices 104.

Within examples, the platform service 710a may maintain this state information in the cloud. Storing this data in the cloud may facilitate restoration of the data should all or a portion of the data become unavailable (e.g., by removal of a playback device 102 from the media playback system 100). Storing this data in the cloud may also enhance portability of the media playback system. For instance, when a playback device 102 (e.g., a portable playback device) is used away from the LAN 111, this playback device 102 and/or a control device 104 may access system state information over the Internet from the platform servers 706. Example techniques for data replication to the cloud are described in U.S. patent application Ser. No. 15/131,244, filed on Apr. 18, 2016, titled “Metadata exchange involving a networked playback system and a networked microphone system,” and issued as U.S. Pat. No. 9,811,314 on Nov. 7, 2017, which is herein incorporated by reference in its entirety and U.S. patent application Ser. No. 16/030,461, filed on Jul. 9, 2018, titled “Distributed Provisioning of Properties Of Operational Settings of a Media Playback System,” and issued as U.S. Pat. No. 10,747,493 on Aug. 18, 2020, which also is herein incorporated by reference in its entirety.

In another aspect, certain functions of the playback device(s) 102 or the control device(s) are moved from these devices to the platform service 710a, so that these functions can take advantage of increased computing capability and connectivity. For instance, rather than implement a queue in the memory 213 of a playback device 102 (which may have limited size), the queue may be instead implemented in the cloud, which may have effectively limitless size (as the cloud may scale based on demand). Example techniques for cloud-based queuing are described in U.S. patent application Ser. No. 14/616,332, filed on Feb. 6, 2015, titled “Cloud Queue Synchronization Protocol,” and issued as U.S. Pat. No. 9,654,459 on May 16, 2017, which is herein incorporated by reference in its entirety. Other techniques for queuing, including techniques to resolve inconsistent versions of queues, are described in U.S. patent application Ser. No. 14/330,694, filed on Jul. 14, 2014, titled “Inconsistent Queues,” and issued as U.S. Pat. No. 9,485,545 on Jul. 14, 2014, which is herein incorporated by reference in its entirety. Other techniques involving multiple queues are described in U.S. patent application Ser. No. 13/341,237, filed on Dec. 30, 2011, titled “Systems and Methods For Networked Music Playback,” and issued as U.S. Pat. No. 9,654,821 on May 16, 2017, which is herein incorporated by reference in its entirety.

When state information is stored on multiple devices, inconsistencies between the data may arise. Within examples, the platform service 710a may be configured to operate as the “source-of-truth” for the media playback system 100. That is, when inconsistencies arise between versions of the data located on the play back devices 102 and/or the control devices 104, the version of the data hosted by the platform service 710a is treated as the correct version.

Within examples, the source-of-truth may be implemented as a blockchain. That is, the state information for the media play back system 100 is stored ultimately in the blockchain. In such an example, edge data caching may reduce interactions with the blockchain, which may have increased benefit relative to conventional data storage given the inherent cost of adding to the blockchain. In such examples, the playback devices 102 (and/or other devices in the media play back system 100) may participate in the blockchain as full nodes or by mining blocks (e.g., as a part of storing data on behalf of the media play back system).

As shown, the platform servers 706 may provide one or more authentication services 710b. The authentication services 710b may include an AuthN service and an AuthZ service. The AuthN service is an identify authentication service that is configured to receive user credentials (e.g., a user name/password, a pin, scanned token, client SSL certificate, among other examples) from a client and, if such user credentials are valid, provide an authorization token (e.g., an OAuth token) in response. The AuthZ service is a service that provides information on the role and permissions that a client with a particular identity (i.e., the token) should be allowed to access.

The platform servers 706 may also provide an API gateway service 710c. The API gateway service 710c provides a point-of-contact outside of the LAN 111 for clients over the WAN (e.g., the networks 107). These clients may include other cloud services, such as voice assistant services, streaming audio services, or IoT services. The clients may also include various apps on control devices 104, including native applications and/or third-party apps. A cloud-based API gateway (e.g., having a known address and URL) may allow for more consistent and/or reliable connections for such clients as compared with attempting to connect to individual media playback systems 100, which may number in the many thousands, each having a different connections and addresses with respect to the broader Internet. Further, an API gateway service may have other advantages, such as protection from denial-of-service attacks.

In combination with the API gateway 710c, the gateway playback device 102n allows the architecture 700 to be agnostic to the entry point. That is, clients may access the media play back system 100 locally via the gateway play back device 102n or through the cloud using the API gateway service 710c. Within examples, clients connected to the LAN 111 may default to the gateway playback device 102n while clients that are not connected to the LAN 111 may connect via the API gateway 710c.

As noted above, some of the services 710 may incur costs during operation. For instance, the AuthN service of the authentication services 710b may be billed per token refresh while the AuthZ service may be billed on throughput/bandwidth usage. As another example, the API gateway service 710c may be billed on a per request basis. In aggregate, over many thousands or millions of media play back systems, such costs may become a significant ongoing expense to support the media play back systems.

FIG. 7 also shows examples of clients. In particular, a control device 104a is representative of an example of the control device 104 implemented using a mobile device and a media play back system control application (e.g., a first party control application). A control device 104b is representative of an example of the control device 104 implemented using a mobile device and a streaming audio service application (e.g., a third party streaming audio service application, such as a SPOTIFY R, PANDORAR, or APPLE MUSIC R app). A third possible client is an NMD 103f. Each of these example clients are configurable to control at least some features on the play back devices 102a-n (FIG. 1A).

Within examples, other IoT devices may also request cached data (e.g., as a client) or otherwise utilize the edge computing resources. The smart illumination device 108 or smart thermostat 110 shown in FIG. 7 are representative of various IoT devices, such as appliances, controllers, sensors, switches, and other IoT devices, that may utilize such edge computing resources, including cached data. While many examples described herein involve the play back devices 102, the control devices 104, and the platform servers 706 for the purposes of illustration, the IoT devices may similarly perform the client roles in requesting data from a gateway device (or may, in some cases, operate as a gateway device).

Within examples, portions of the state information are cached locally. For the purpose of illustration, FIG. 7 shows the play back device 102n as including an edge data cache 760. Within examples, data from the services 710 is cached locally in the edge data cache 760. The play back device 102n may use the cached version of the data, which may avoid the need for some clouds calls thereby reducing cloud costs.

Within examples, the edge data cache 760 may be stored in a portion of the memory 213. Yet further, in some examples, the edge data cache 760 may be maintain in random access memory (RAM), which may avoid write cycles on persistent flash data storage thereby prolonging the lifetime of such flash data storage. Since the playback devices 102 are seldom powered-off (instead entering a low-power state when not in use), the cache can be maintained in RAM for sufficiently long periods.

In examples, a playback device having an edge data cache may operate as a “gateway” or “point-of-contact” to the cloud. By way of example, the playback device 102n is configured to operate as a gateway play back device 102n. The gateway play back device 102n may handle various requests, such as authorization and service requests, from clients, such as the controllers and other players, using cached state information. In this way, a playback device 102 with an edge data cache 760 may avoid cloud calls from itself but also from other devices on the LAN 111.

If the gateway playback device 102n is unable to handle a request (e.g., because it does not have corresponding state information cached or its cached data is stale), the gateway play back device 102n may request this data from the cloud and, after receiving the requested data, respond to the requesting client. The gateway play back device 102n may also update its edge data cache with the requested data. Then, the gateway playback device 102n may fulfill subsequent requests locally using the edge data cache rather than the cloud.

Within examples, any playback device 102 within the media play back system may have the capability of performing caching, or operating as a gateway playback device. On the other hand, not every playback device 102 in the media playback system 100 is necessarily configured to cache and/or operate as a gateway playback device at the same time. Within examples, certain clients may be configured to operate with specific gateways, which may provide a consistent, more reliable source of state information.

Within examples, the roles of gateway and data caching may be implemented on two or more playback devices 102, which function in concert to provide edge computing resources. For instance, one (or several) playback devices 102 may be configured to operate as a gateway play back device, while another play back device (or several) is configured to maintain an edge data cache. In such cases, the gateway may request such data from the caching playback devices 102 via the LAN 111.

As such, the media play back system 100 may select one, several, or all playback devices 102 in a system to cache and/or operate as a gateway playback device. This allows the media playback system 100 to be dynamic around the number of players and controllers in a household. Example media playback systems 100 may include anywhere from one playback device to many (as illustrated by FIG. 1A), and the number of players may change over time as players are added and removed. Due to their design and intended use, portable play back devices 102 (e.g., wearables such as earbuds and headphones as well as portable speakers for out-loud play back) may be regularly temporarily removed for use on-the-go, thereby adding to the dynamic topology of the media play back system 100. Similarly, example media play back systems 100 may contain a variable number of control devices 104 that varies as the users within a household connect different control devices to the media play back system 100. Like the portable play back devices 102, the control devices 104 may regularly brought outside the home, which may temporarily disconnect such devices from the LAN 111 and the edge computing resources located on that network.

Some play back devices 102 may be preferred as a caching/gateway playback device for various reasons, such as processing resources (e.g., higher resourced players may be preferred as they have more spare computing capacity), uptime (players with greater uptime may be preferred), network connectively (players with a more stable and/or faster (e.g. wired) connection may be preferred), or type (e.g., portable play back devices having a greater tendency to be brought away from the LAN 111 may be not preferred). As another example, players with certain features (e.g., a soundbar or other player configured to operate as a home theater coordinator or a voice assistant capable player) may be selected based on its role with respect to other players or the system as a whole.

In some examples, one playback device 102n may be selected to cache on behalf of a set of other play back devices. For instance, one play back device 102 (e.g., the group coordinator) may be selected to operate as the gateway for members of a group (e.g., as illustrated in FIG. 3E). Similarly, one playback device 102 (e.g., the zone coordinator) may be selected to operate as the gateway for a bonded zone (e.g., a stereo pair or a surround sound configuration, as illustrated in FIGS. 3B, 3C, and 3D). Along the same lines, one playback device 102 may be selected to operate as the gateway for all playback devices in a saved group (e.g., an Area as illustrated in FIG. 3A), either all of the time or when the saved group is formed.

In an example, a playback device 102 may configure itself as a caching/gateway playback device based on its capabilities relative to other playback devices 102 in the media play back system 100. Alternatively, another network device or set of devices, such as the platform service 710a, may configure one or more playback devices 102 as a caching/gateway playback devices using the reasons described above, or alternatively, for other suitable reasons. Further example features of a point-of-contact playback device, including selection of a caching/gateway playback device are described in U.S. Provisional App. No. 63/112,459, filed on Nov. 11, 2020, and titled “Control With Distributed Command Processing” and PCT App. No. PCT/US21/36392, filed on Jun. 8, 2021, and titled “Control With Distributed Command Processing,” which are each herein incorporated by reference in their entirety.

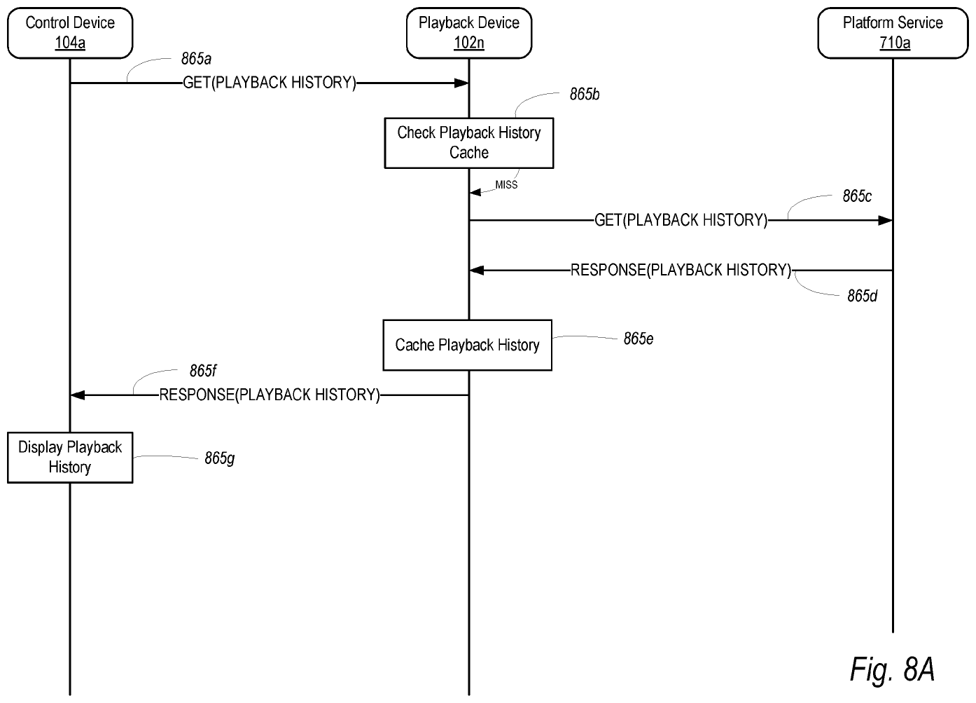

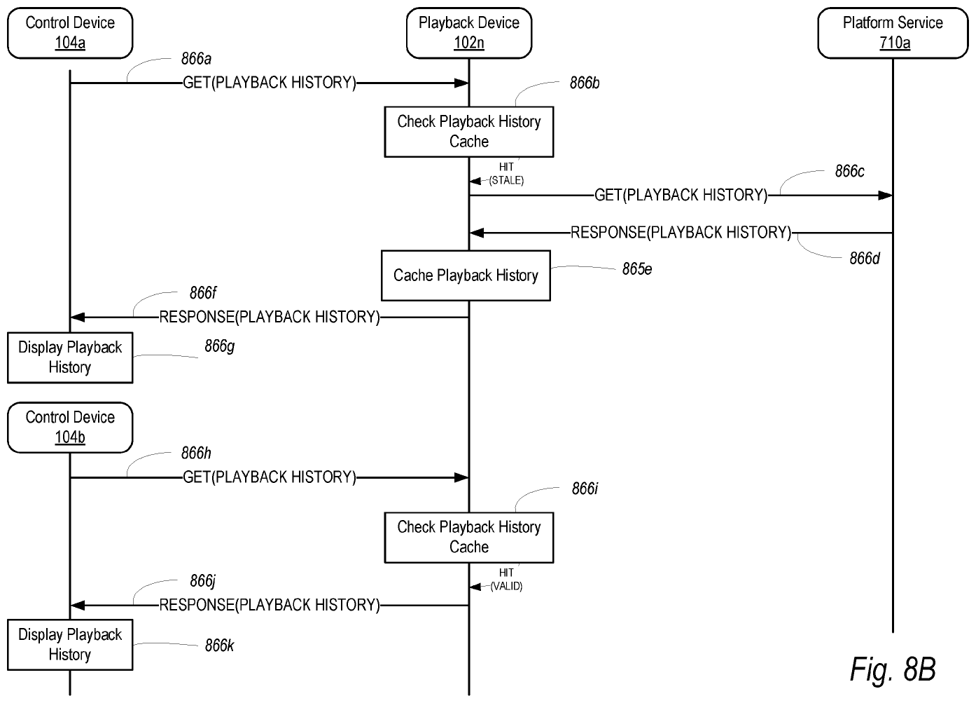

As noted above, state information, such as system topology, service information, and personalization data, may also be cached in the edge data cache. To illustrate, FIG. 8A is a message flow diagram illustrating data exchanges between devices of the architecture 700 to display play back history information on a control interface. Play back history (i.e., recently played media items) is intended as one illustrative example of state information caching in the media playback system 100. Further, the message flow diagram of FIG. 8A shows the control device 104a as an example client device and the playback device 102 as an example gateway playback device as illustrative devices.

Playback history (i.e., recently played media items) is intended as one illustrative example of state information caching in the media playback system 100. Examples involving tracking activity in a media playback system, including playback history, are described in U.S. patent application Ser. No. 13/338,724, filed on Dec. 28, 2011, titled “Methods and Systems To Select an Audio Track,” and issued as U.S. Pat. No. 9,665,339 on May 30, 2017, which is herein incorporated by reference in its entirety. Other examples involving tracking activity in a media play back system, including playback history, are described in U.S. patent application Ser. No. 14/300,564, filed on Jun. 10, 2014, titled “Providing Media Items From Playback History,” and issued as U.S. Pat. No. 9,672,213 on Jun. 6, 2017, which is herein incorporated by reference in its entirety. Yet further example are described in U.S. patent application Ser. No. 14/186,924, filed on Feb. 21, 2014, titled “Media Content Based on Playback Zone Awareness,” and issued as U.S. Pat. No. 9,226,072 on Dec. 29, 2015, which is herein incorporated by reference in its entirety.

The message flow diagram begins with requesting data. At 865a, the control device 104a sends a request for playback history data to the play back device 102n. In examples, such a request may take the form of an HTTP request method such as GET which reference a resource in a namespace to get information about the resource. Clients, such as the control device 104a may also send commands that direct the playback device to perform any of the example features described herein, as well as other features of play back devices. In an example, the commands may take the form of an HTTP methods such as POST, which reference a resource in a namespace to set certain values of the resource. For instance, a POST request in a play back namespace may set a media item to play back. An example GET request to request playback history is shown as follows:

GET /v1/history/containers
Content-Type: application/json

In some examples, the playback history cache may include playback history for multiple users. In such cases, the request for playback history data may reference a user account, perhaps in a reference to a resource or via a token indicating an identity. Then, the play back device 102n may use this user account to retrieve playback history associated with this user account.

More broadly, playback history within the media playback system 100 may be organized using various parameters. In addition to user account noted above, playback history may be structured or otherwise maintained according to various groupings, such as by zone (room), by group (e.g., a group of two or more rooms), by a bonded pair, by area. Yet further, play back history may be organized by streaming audio service (and perhaps by user accounts of each service). Other example parameters include location (e.g., playback history for a local or remote session for a portable playback device). Other types of state information may be similarly organized by one or more parameters. The cached data may reflect such organization.

At 865b, the playback device 102n checks a playback history cache. For instance, the play back device 102n may determine whether the edge data cache 760 includes or excludes a valid playback history cache. Within examples, the playback history cache is valid if it has not expired either through time or by the playback device 102n being notified that the cache has become stale, as discussed in further detail below.

In some implementations, the edge data cache is utilized even though it is not necessarily entirely current (i.e., when some differences exist between the edge data cache and the “source of truth” in the cloud). For instance, as noted above, the edge data cache may be considered valid if it has not expired through time (e.g., a period of time) or some other factor. During this time period, the “source of truth” may change somewhat, but the cache is still considered valid. Such a techniques may be implemented for certain types of data where inconsistencies between cached and cloud data do not impact user experience.

Different types of data (e.g., different namespaces) may have different expiration periods. For instance, some types of data that changes less frequently (e.g., registered services or device capabilities) may be assumed valid for a relatively longer period of time as compared with data that changes more frequently (such as play back history).

The specific caching rules for different types of data may vary based on the edge computing resources available. When more storage is available, the system 100 as a whole may cache more data. This may include more types of data (e.g., more namespaces) or more of a particular type of data (e.g., a longer playback history). On the other hand, when edge computing resources are relatively limited, the system 100 may determine to only cache certain data (e.g., data that is accessed more often or for which local access is otherwise more useful).

Caching rules may also vary based on a user's subscription status. For instance, a first type of user account (e.g., a premium or paid) user account may be permitted more frequent refreshes from the cloud relative to a second type of account (e.g., unpaid), as the cost of more frequent cloud access may be a offset by subscription fees. As another example, different sources of the data (e.g., different streaming audio service) may be refreshed more or less quickly. As another example, a paid subscription to a particular streaming audio service may enable caching of data related to that service. Other examples are possible as well.

Based on determining that the edge data cache 760 excludes a valid playback history cache (i.e., a cache miss), at 865c, the playback device 102n goes to the cloud to attempt to retrieve the play back history. In particular, the playback device 102n sends a request for play back history data to the platform service 710a. In some examples, this request may parallel the request from the control device 104a. As such, in operating as a gateway, the play back device 102n is acting as a proxy between the client (the control device 104a) and the platform service 710a for requests that result in a cache miss.

After receiving a request for a state information, such as the play back history, one or more platform servers 706 that are involved in providing the platform service 710a may retrieve the state information from a database or other data storage. Such a database may include stored state information for a plurality of media playback systems (e.g., multiple instances of the media playback system 100), as part of supporting the operations of these systems in providing the services 710.

At 865d, the platform service 710a sends a response to the request for playback history data to the playback device 102n. An example successful response is shown as follows:

HTTP/1.1 200 OK
Cache-Control: private, max-age=300, stale-whilerevalidate=
30, stale-if-error=300
Content Type: application/json
ETag: “<hash-of-data-object>”
. . .

| | |
|---|---|
| { | “data” : [ { “container”: { ... } , |
| | “group” { ... } , |
| | “created”: “2020-04-23T18: 23: 43Z” } , ... ], |
| | “version” : “<hash-of-data-object>” } |

As shown, the response indicates data including a set of most recent entries in a playback history (e.g., the 40 most recent media items played.

The response also includes information to facilitate caching. In particular, the header of the response includes an entity tag (“ETag”) to identify the particular version of the resource (i.e., the playback history data object), which in this case is in the form of a hash of the playback history data object. As explained in further detail below, the ETag may be used to determine whether the cached playback history data has changed (and thus needs to be re-requested from the platform service 710a.

The header also indicates cache control directives, which govern how the cached version of the resource is maintained. These cache control directives include a time-to-live period, which in this example is 300 seconds. At the end of this period, the cached version of the play back history data object is considered stale. The cache control directives also include a “private” directive, which limits caching to the player.

At 865e, the play back device 102n caches the play back history in the edge data cache 760. In particular, the playback device 102n may store the playback history data object along with the associated ETag indicating the version of the data object. This cached version of the object may be used to respond to subsequent requests, as illustrated in following examples.

At 865f, the playback device 102n sends a response to the request for playback history sent by the control device 104a. Within examples, this response may parallel the response received from the platform service 710a. At 865g, the control device 104a uses the requested resource by displaying an indication of the play back history on a control interface (e.g., the control interfaces 540a and 540b (FIGS. 5A and 5B) via a user interface (e.g., the user interface 440 in FIG. 4).

While the cached play back history remains valid and not stale, subsequent requests from clients may be serviced using this cached data. To illustrate, FIG. 8B is another message flow diagram. At 866a, the control device 104a sends a request for playback history data to the play back device 102n.

At 866b, the play back device 102n checks the playback history cache for a valid cached play back history resource. The playback device 102n may determine whether the cached play back history resource is valid (not stale) based on the cache control directives and/or the ETag value in the request. For instance, the playback device 102n may determine whether the time-to-live period has expired, and if so, determine that the cache is stale.

Further, the request from the control device 104a may include the most recent known value of the ETag for the requested resource (e.g., the ETag of the playback history data object), perhaps in an “If-None-Match” header. This header instructs the playback device 102n to send back the requested resource along with a 200 (OK) status if the most recent known value of the ETag is different from the version of the ETag corresponding to the cached resource on the play back device 102n. Alternatively, if the most recent known value of the ETag is different from the version of the ETag corresponding to the cached resource on the playback device 102n, the playback device 102n sends back a 304 (Not Modified) response without the requested resource (as the version on the client is up-to-date) (assuming the cache is not stale).

In this example, the playback device 102n determines that the cache is stale. Based on this determination, the play back device 102n the playback device 102n goes to the cloud to attempt to retrieve the play back history. In particular, at 866c, the play back device 102n sends a request for playback history data to the platform service 710a. Further, like the request from the control device, the request from the playback device 102n may include the most recent known value of the ETag for the requested resource (e.g., the ETag of the play back history data object), perhaps in an “If-None-Match” header.

At 866d, the platform service 710a sends a response to the request for playback history data to the play back device 102n. An example successful response is shown as follows:

HTTP/1.1 304 NOT MODIFIED
Cache-Control: private, max-age=300, stale-whilerevalidate=
30, stale-if-error=300
Content Type: application/json
ETag: “<hash-of-data-object>”

As shown, in contrast to the FIG. 8A example, this response does not include a play back history data resource. Instead, the response includes a 304 Not Modified status in the header, which instructs the playback device 102n that the cached version of the resource is still up-to-date.

As such, at 866e, the playback device 102n re-caches the playback history in the edge data cache 760. In particular, the playback device 102n may re-valid the cached play back history data object along with the associated ETag indicating the version of the data object for another time-to-live period indicated in the cached control directives.

At 866f, the play back device 102n sends a response to the request for playback history sent by the control device 104a. At 866g, the control device 104a uses the requested resource by displaying an indication of the play back history on a control interface (e.g., the control interfaces 540a and 540b (FIGS. 5A and 5B) via a user interface (e.g., the user interface 440 in FIG. 4).

While display is one example of using a requested resource, the media play back system 100 may use requested resources in many different ways. One example is local processing of a voice input. For example, when locally processing a voice input, such as “Hey Sonos, what was that last song I played?”, a NMD 103 may request state information, such as play back history data, from a gateway device. If the requested data is cached in an edge data cache, requesting this data from the cloud may be avoided. Using cached data in local voice processing is another example of how edge computing in the media play back system 100 may enhance privacy and/or security.

In some cases, a gateway playback device, such as the playback device 102n, may function as a gateway to more than one client (e.g., another play back device 102 or another control device 104). By way of example, in FIG. 8B, at 866h, the control device 104b sends a request for playback history data to the play back device 102n.

At 866i, the playback device 102n checks the playback history cache for a valid cached playback history resource. In this example, the playback device 102n determines that the cached version of the playback history data resource is not stale. Based on this determination, at 866j, the playback device 102n sends a response to the request for playback history sent by the control device 104b using the cached version of the playback history data resource. Note that in some examples, the playback device 102n might not send the actual cached version of the data resource, but may instead respond with an indication that the version of the resource already on the requesting client is up-to-date, such as a 304 Not Modified status in the header.

At 866k, the control device 104b uses the requested resource. In this example, the resource is used by displaying an indication of the playback history on a control interface. Other examples are possible as well, including any use of any data that could be stored as state information or other types of data associated with the media play back system 100.

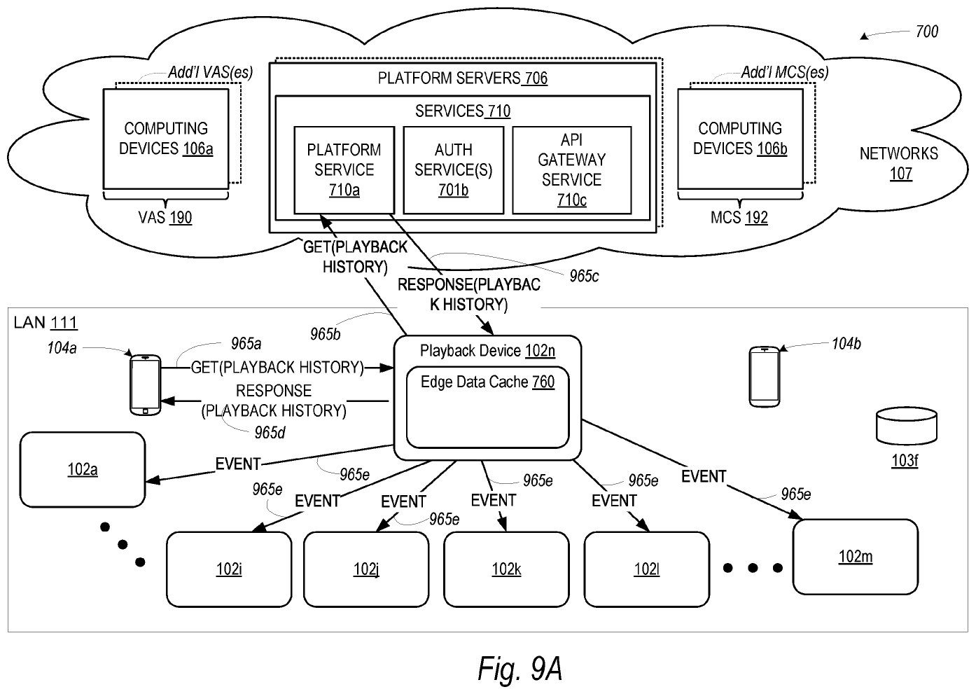

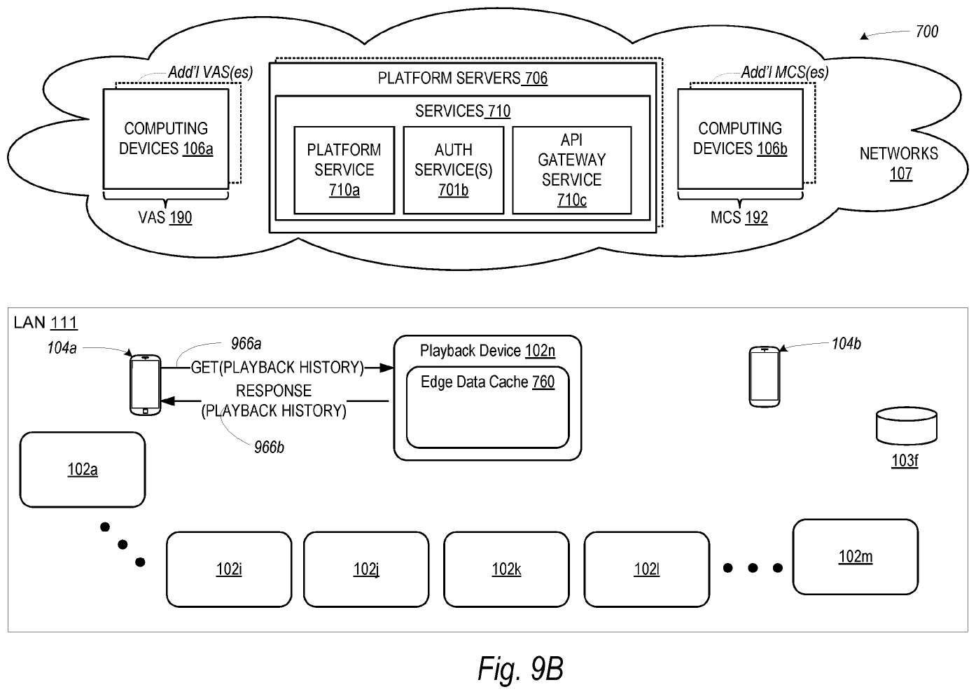

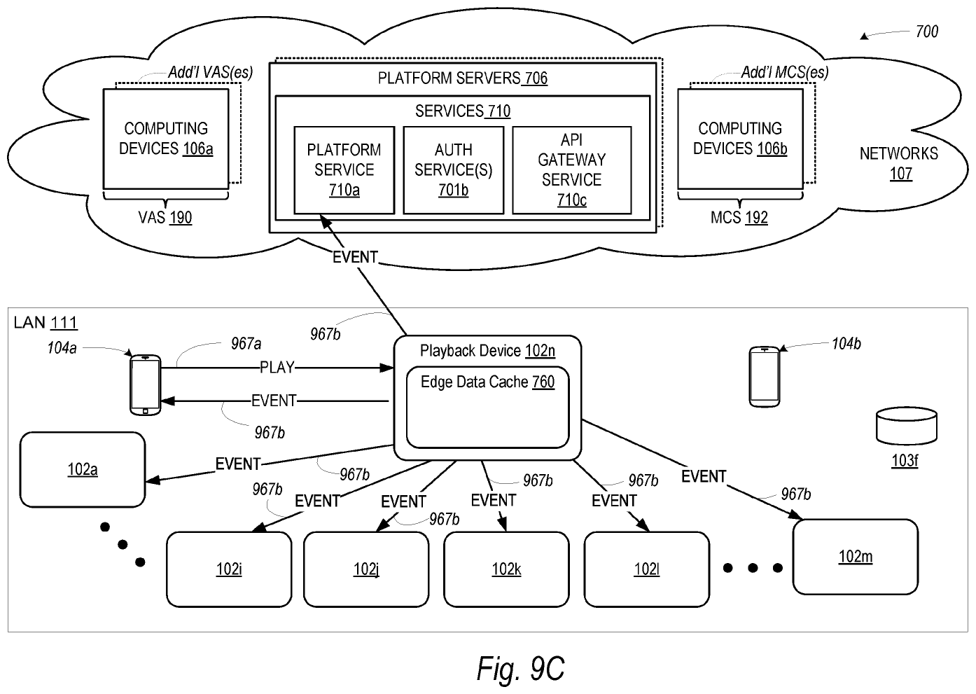

FIG. 9A is an example of requesting playback history by the control device 104a while on the LAN 111, which is similar to the FIG. 8A example. At 965a, the control device 104a sends a request for playback history to the play back device 102n. The playback device 102n determines whether a valid version of the playback history is cached in the edge data cache 760. If not, at 965b, the playback device 102n sends a request for playback history to the platform service 710a, and at 965c, receives a response from the platform service 710a. The play back device caches the playback history data resource in the edge data cache and, at 965d, sends a response to the control device 104a with the playback history.

As indicated above, within examples, any playback device 102 may be sent a request for a data resource, even if the resource corresponds to another playback device 102. For example, the play back device 102n may be sent a request for playback history data of the playback device 102a. The playback device 102n might not have this resource locally, but may be able to retrieve the resource from the platform service 710a. One possible advantage of this architecture is that the control devices 104a do not need to wait for responses from each playback device 102 in the media playback system 100 to display, for instance, playback status’, but can instead retrieve this state information from a single play back device operating as a gateway.

As noted above in section II, the playback devices 102 and/or the control devices 104 may share state information data with one another via the LAN 111. Such data sharing may follow an event/subscriber model, whereby subscribers to certain data (e.g., a certain namespace) may receive notifications when resources within that data are altered, which facilitates synchronization of this data among the devices in the media playback system 100. Example techniques for data replication among playback devices are described in U.S. patent application Ser. No. 13/341,235, filed on Dec. 30, 2011, titled “Systems and Methods for Player Setup Room Names,” and issued as U.S. Pat. No. 9,344,292 on May 17, 2016, which is herein incorporated by reference in its entirety.

As an example, the playback device 102n may notify other devices in the media play back system 100 when a new version of a resource is available. Such notifications may follow an event/subscriber model, whereby subscribers (e.g., to a certain namespace, such as play back data) are sent notifications (e.g., events) when a resource is changed. In this example, at 965e, the play back devices 102a-102n are sent event notifications indicating the updated playback history resource.

In some examples, these notifications indicate the version of the resource, perhaps by way of the ETag. The version in the notification may indicate that a later version is available, which may cause the receiving subscribers to take action. For instance, the playback devices 102a-n may request the new version of the resource. Alternatively, the playback devices 102a-n may mark their version of the resource as stale, and then request the updated version of the resource when the resource is needed.

FIG. 9B is another example of requesting playback history by the control device 104a while on the LAN 111, which is similar to portions of the FIG. 8B example. In this example, the playback history data is already cached, so a request for the data can be serviced from the edge data cache. At 965a, the control device 104a sends a request for playback history to the playback device 102n. The play back device 102n determines whether a valid version of the play back history is cached in the edge data cache 760. If so, at 965b, the play back device 102n sends a response to the control device 104a with the play back history from the edge data cache 760.

FIG. 9C is an example of a control device 104 setting a resource. In particular, at 967a, the control device 104a sends a command to start playing back a playlist on one or more particular playback devices. This command may take the form of an HTTP POST to set the value of a resource that controls a queue or a now playing resource on the one or more particular play back devices. Although this command is sent to the play back device 102n (as a gateway), the command may target any of the play back devices 102 in the system. Additional examples of such targeting are described in U.S. Provisional App. No. 63/112,459, filed on Nov. 11, 2020, and titled “Control With Distributed Command Processing” and PCT App. No. PCT/US21/36392, filed on Jun. 8, 2021, and titled “Control With Distributed Command Processing,” which were previously incorporated by reference herein in their entirety.

After receiving the command, the play back device 102n updates the corresponding resource. At 967b, the playback device 102n then sends data to other playback devices 102n (including the targeted playback device), the control device 104a, and the platform service 710a notifying them of the updated resource. The targeted playback devices update their resource, which starts playback according to the command.

In this example, this data is sent to these devices as example subscribers to this resource (or the namespace that includes the resource). In other examples, the playback device may update additional or fewer devices. For instance the playback device 102n may update only the platform service 710a (and may not directly update any other playback device(s)), and then platform service 710a may in turn notify other devices including other play back devices. Further examples of such communication are described in U.S. Provisional App. No. 63/112,459, filed on Nov. 11, 2020, and titled “Control With Distributed Command Processing” and PCT App. No. PCT/US21/36392, filed on Jun. 8, 2021, and titled “Control With Distributed Command Processing.” which were previously incorporated by reference herein in their entirety.

Within examples, the platform servers 706 may send an invalidate cache command to the gateway playback device(s) 102. Since the platform servers 706 are the “source-of-truth,” the platform servers know when state information or other resources have changed values, and as such, have caused cached version of these resources to become stale. For instance, the media playback system 100 may have a subscription or other entitlement to a streaming audio service (e.g., a native radio service). Access to such services (e.g., via a token) may be cached in the edge data cache. When the entitlement expires, the platform servers 706 may send an invalidate cache command to the gateway playback device(s) 102 to prevent further access to such entitlements.

While playback history is provided as an example, the examples are applicable to any example state information disclosed herein, as well as other types of state information that may be stored or maintained in an IoT system. Data resources that are accessed relatively more frequently than they are changed may provide greater savings from edge caching. Other examples of data resources that may benefit from caching include device capabilities (e.g., physical line-in capable, voice capable, Bluetooth capable, etc.) and settings, such as user accounts (including streaming audio services, voice assistant services, and other IoT services), music streaming protocol (e.g., AIRPLAY R; or SPOTIFY CONNECT®) settings, line-in settings, touch control settings, as well as other system or device level settings, such as calibration and equalization settings.

Other state information includes device capabilities. Various playback devices 102 may have different capabilities and these capabilities may influence how the devices interact with one another and with the cloud. For instance, if a first playback device 102 includes a physical line-in connection and a second playback device 102 does not have this capability, the control interface on the control devices 104 may show the line-in as a source for the first playback device 102 but not for the second playback device 102. As such, the media play back system 100 may maintain state information representing device capabilities, which may be cached as well.

In addition to the support for such protocols, the state information (and thus the edge data cache) may include associated settings and/or configuration. For instance, continuing the example above, the state information may include not only whether a given playback device 102 includes a physical line-in, but whether a signal is present on that input. Having this information such information available locally may have various benefits, such as faster update of status' displayed on the controller interfaces 540).

Another benefit may be that device specifics can be abstracted away from cloud services (such as other cloud services, not acting as the source-of-truth for state information). That is, instead of telling a cloud service which devices are present, the system can indicate what capabilities are present based on local data, thereby notifying the cloud service that the system is capable of performing certain cloud-originated commands without revealing device specifics. For instance, edge-cached state information may indicate whether certain devices are voice capable (e.g., that they are NMDs 103 or implement NMDs 103) and further which cloud-based voice assistants are enabled. In this example, data at the edge may be used to enable voice processing via a voice assistant without revealing specifics of the devices in the media play back system 100.

Other example device capabilities are streaming protocol (e.g., AIRPLAY®) and streaming interface (e.g., BLUETOOTH®) support. To illustrate, the state information may include a history of BLUETOOTH® connections, which may facilitate quicker connections. For instance, a second playback device 102 may used cached connection information from a connection established by first play back device 102 to establish a similar connection itself.

Such device capabilities may be used for local voice processing. For instance, a user may speak the voice input “play my favorites on Living Room using Airplay.” Assuming the availability of cached state information, in processing such a voice input, an NMD 103 may identify the user's favorites, the Living Room devices, and whether those devices support Airplay. If any of this state information is not cached, it can be requested from the platform servers 706 and cached for later use, as described with the playback history example in FIGS. 8A-8B.

To illustrate caching with another type of data, as described in more detail in the following examples, certain authorization data may be cached in an edge data cache to reduce interaction with the cloud. That is, instead of querying the authentication services 710b, certain queries may be handled by data stored in the edge data cache 760. As noted above, such caching may reduce cloud calls, and their associated costs.

### IV. Example Edge Caching of Authorization Data in a Media Playback System

In some examples, clients may be required to be authenticated before retrieving or setting data resources within the media play back system. As noted above, example clients include controllers, which may be first-party (e.g., a controller application developed by the manufacturer of the media play back system to provide control functionality) and third-party (e.g., applications developed by various content services, such as streaming audio services, that are capable of control of the playback devices within the media play back system (perhaps via support of one or more application programming interfaces (API) s). Such authentication may help to prevent unwanted access to devices within the media playback system 100.

In an example authentication process, a client may send authentication credentials (e.g., a user name/password, a pin, scanned token, client SSL certificate, among other examples) to a first authentication service (e.g., an AuthN service, referred to as authentication service 710b-1). In return, the authentication service 710b-1 provides a token (e.g., an OAuth token) to the client.

The client may then authenticate with the play back devices 102 using the token. For instance, when performing a restricted action on a playback device 102, the client may send the token to the play back device 102. Example control protocols or APIs may utilize HTTP requests and responses. In such examples, the token may be transmitted using HTTP headers. The token authenticates the client (i.e., this client is who they say they are), but might not be configured with any additional information about the client's “role.”

In role-based access control, a subject (e.g., the client) has a role on the object. In an example, the media playback system 100 (and all constituent playback devices 102 in the household) are the object. In such an example, the client may have a certain role with respect to all of the play back devices 102 in the system 100. In other examples, the media play back system 100 may be divided into two or more objects (e.g., based on rooms or zones configured within the media play back system 100). In this example, a client may have different roles in different zones (or may have the same role in all zones).

Within examples, the playback device may resolve a role for the client. A second authentication service (e.g., AuthZ, referred to as authentication service 710b-2) executing on a computing system (e.g., on a cloud computing system) may maintain token-to-role mappings to facilitate role resolution. For instance, after receiving a token from a client, the playback device 102 may send the token to the second authentication service, which may return a set of effective roles for that token.

After resolving the role for the client on the subject, authorization management may further involve resolving permissions for the role. Within examples, the second authentication service (e.g., AuthZ) may maintain role-to-permissions mappings to facilitate permissions resolution. For instance, after receiving a role, the playback device 102 may send the role to the second authentication service, which may return a set of permissions for that token.

As described in more detail in the following examples, certain authorization data, such as token-to-role mappings and/or role-to-permissions mappings, may be cached to reduce interaction with the cloud. That is, instead of querying the authentication services 710b, certain queries may be handled by data stored in the edge data cache 760.

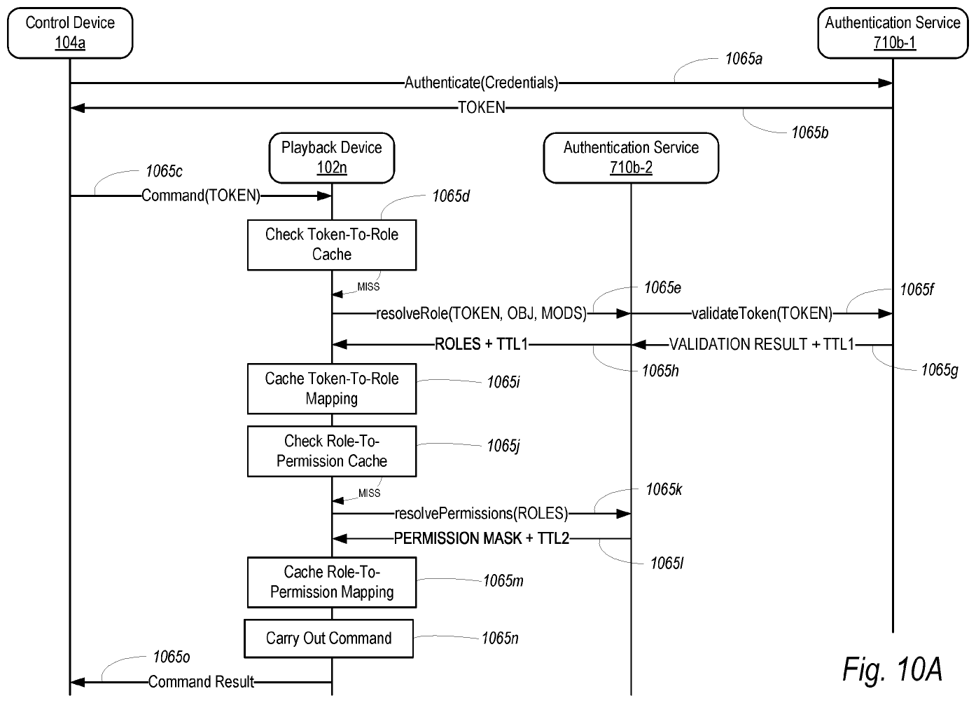

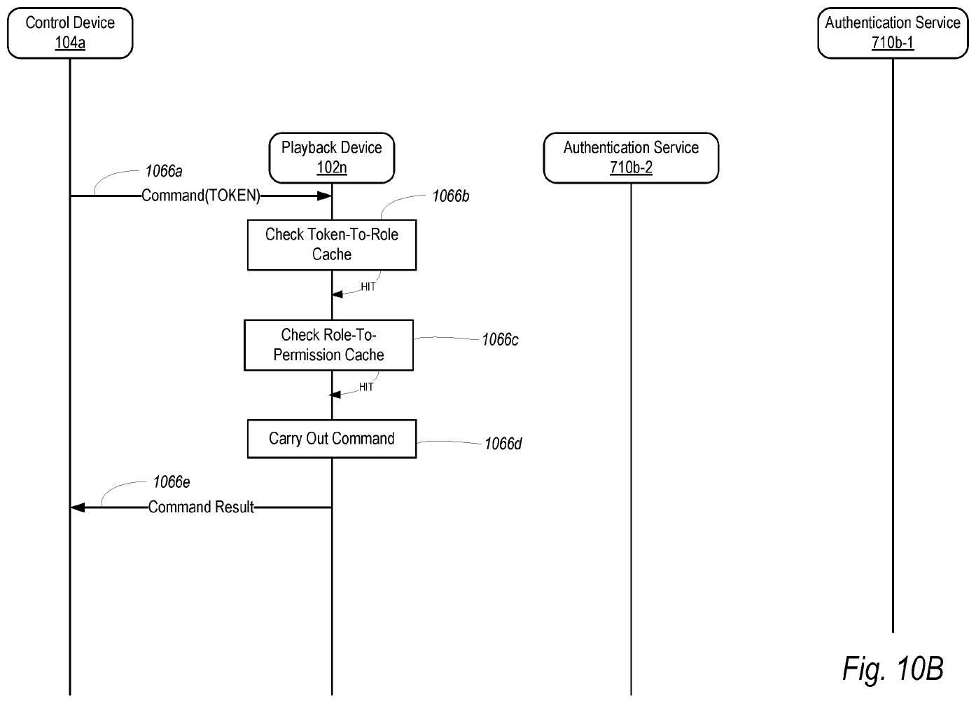

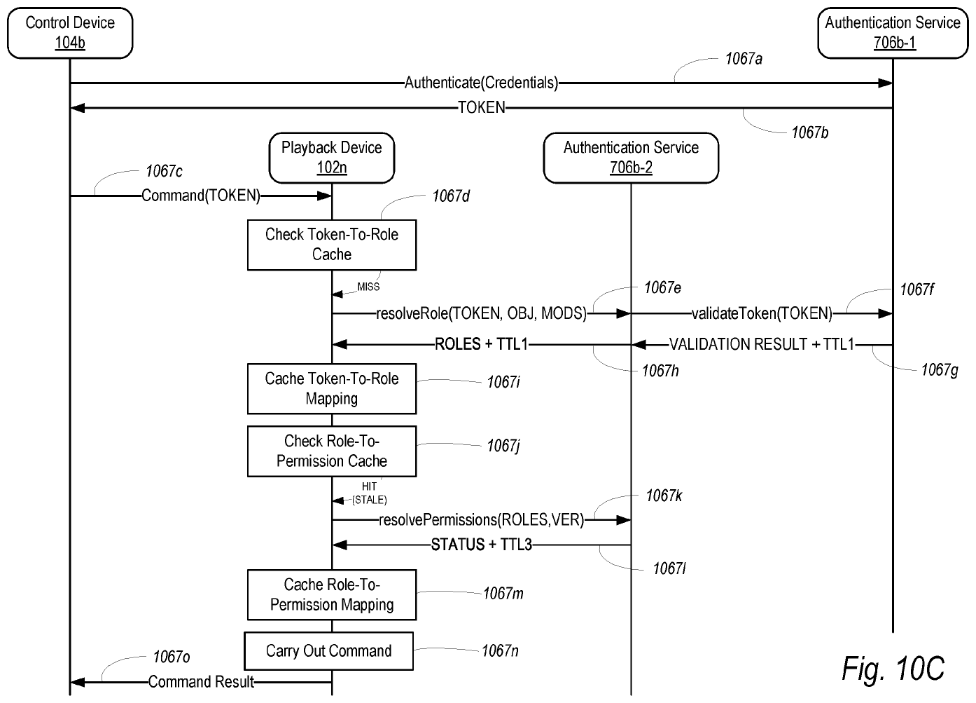

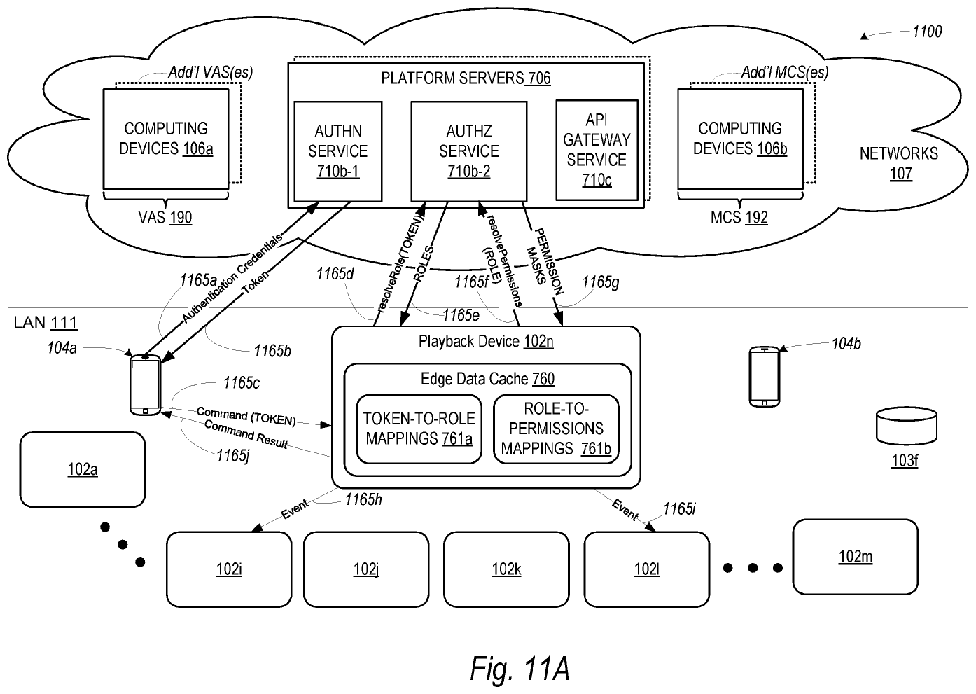

FIG. 10A is a message flow diagram illustrating data exchanges between devices of the architecture 700 to perform authorization of a new client (the control device 104a) with one of the services 710, such as the platform service 710a. The message flow diagram begins with authenticating a client. In some example implementations, all commands require authentication. In other example implementations, local commands on the LAN 111 via a gateway playback device might not require authentication while cloud-based commands via the API gateway 710c may require authentication. Other examples are possible as well.

At 1065a, the control device 104a sends authentication credentials to the authentication service 710b-1. The authentication service 710b-1 determines whether the authentication credentials are valid, and if so, sends a token to the control device 104a at 1065b. This token is referred to in this example as a first token. In some examples, the authentication credentials are in the form of a username and password.

At 1065c, the control device 104a sends a command to the playback device 102n. Example commands include various commands that direct the playback device to perform any of the example features described herein, as well as other features of playback devices. In an example, the commands may take the form of HTTP request methods such as GET and POST, which reference a resource in a namespace to get information about the resource or to set certain values of the resource. For instance, a POST request in a playback namespace may set a media item to play back.

Before performing a restricted action (e.g., via the command), the client authenticates with the playback device 102n. As shown in FIG. 10A, the command includes the first token. The first token may be referenced in a header (e.g., an HTTP header) possibly along with other information to facilitate the command. This token may be used to authenticate the client with the playback device 102n.

After receiving such a command, the playback device 102n attempts to resolve the role(s). In particular, at 1065d, the playback device 102n checks a token-to-role cache. For instance, the playback device 102n may determine whether the edge data cache 760 includes or excludes a token-to-role mapping corresponding to the first token (e.g., in the token-to-role mappings 761a) (FIG. 7). Based on determining that the edge data cache 760 excludes a token-to-role mapping corresponding to the first token (i.e., a cache miss), the playback device 102n goes to the cloud to attempt to resolve the roles.

In particular, at 1065e, the playback device 102n sends a request for a role corresponding to the first token to the authentication service 710b-2. As illustrated in FIG. 10A, the request includes indications of the first token, the object (e.g., the media play back system 100, or the playback device 102n, depending on scope), and any modifiers. The request may take the form of a HTTP POST request with the indications carried in a header. An example POST request to resolve roles is shown as follows:

```
POST /authz/v1/role/resolve HTTP/1.1
. . .
{
  “token”: “OAUTH TOKEN”,
  “objectId”: “012345ABCDEF”, // serial number
  “objectType”:
  “player”,
  “attributes”: { // attributes can be expanded
    “route”: “lan”, // lan|wan|bluetooth
    “openLanEnabled”: true / /
  }
}
```

As shown, the HTTP header of the POST request includes an OAuth token, an objectID (indicating the serial number of the playback device 102n), an objectType (including that it's a player, or play back device), as well as some attributes. As discussed in further detail below, such attributes may modify the permissions granted to a role.

At 1065f, the authentication service 710b-2 sends a request to validate the first token to the authentication service 710b-1. Then, at 1065g, the authentication service 710b-1 replies with a validation result. If the first token is valid, the validation result indicates that the first token is valid and also provides an indication of a first time-to-live period (denoted as “TTL1”). This first time-to-live period indicates how long the authentication token remains valid. After a time-to-live period expires, the associated cached data is considered stale and cannot be used to resolve roles.

When the validation result is successful, the authentication service 710b-2 determines the token-to-role mapping for the first token. The authentication service 710b-2 maintains or has access to token-to-role mappings for each token. The authentication service 710b-2 may act as a “source of truth” for such mappings in the authentication system.

Such mappings may be created via a client having certain permissions (e.g., administrator or owner permissions) using a suitable user interface (e.g., the user interface 440 in FIG. 4) in order to assign certain users and/or their respective client devices to specific roles within the media playback system 100. In some examples, some clients may be unknown or anonymous such that there is no mapping for that client. In such examples, the clients may be automatically assigned to a specific role (e.g., guest). Such clients may be latter elevated to a different role via the user interface.

Within examples, determining the token-to-role mapping for the first token may involve querying a database or other data storage structure for a role matching the object and the token. Such a query may return an indication of the role(s) corresponding to the token on the object. An indication of such roles may be ultimately provided to the playback device 102n in a response.

In further examples, the role(s) may be modified based on one or more modifiers. One example of a modifier is the route of the client command. As illustrated above in the example POST request to resolve roles, example values of the route modifier include LAN, WAN, and Bluetooth. Commands arriving via the LAN and/or Bluetooth routes may be modified to a relatively higher role, as connection via such routes is generally more trustworthy than a WAN route (e.g., from a guest to an owner role). That is, a client on a secure LAN or a Bluetooth connection is more likely to be a trusted client than a client attempting to connect via the broader internet. In other examples, all three routes may modify the role differently. For instance, a LAN route may modify the role to a higher role, the Bluetooth route might not modify the role, and the WAN route may lower the role. Many examples of different modifications based on the routes are contemplated.

At 1065h, the authentication service 710b-2 sends a response to the playback device 102n. If the first token is valid, the response will indicate a success. An example successful response is shown as follows:

```
HTTP/1.1 200 OK
Cache-Control: private, max-age=300, stale-whilerevalidate=
30, stale-if-error=300
ETag: 8ccsefca3640bf81ale10j2w72d98rbn
Content-Type: application/json
. . .
  “status”: “OK”,
  “uid”: “asdfghjkl”, // okta user id
  “luid”: “12345”, // the legacy user id,
  “apiKey”: “DED3E12F-AE8A-45BC-BFB6-A91C80D87EC7”,
  “policyKey”: “8dLS-STphqyG_fezbJS83zK-7BU”
}
```

As shown, the response indicates “OK” as the “status” representing a successful response to the request to resolve roles. The HTTP header also includes a policy Key which indicates the role(s) corresponding to the first token. This role is referred to herein as a first role.

The HTTP header of the response also includes information to facilitate caching. In particular, the header indicates the first time-to-live period, which in this example is 300 seconds. The header also includes an entity tag (“ETag”) to identify the particular version of the resource (e.g., the policyKey). As explained in further detail below, the ETag may be used to determine whether the policyKey has been changed (and thus needs to be re-requested from the authentication service 710b-2).

At 1065i, the playback device 102n caches the token-to-role mapping in the edge data cache 760 (e.g., in the token-to-role mapping 761a). In some examples, the caching is maintained for the first time-to-live period and removed from the cache when this period expires. In other examples, the caching is considered valid for the first time-to-live period (and can't be used to resolve roles after invalidated as it is considered stale). In either case, the cached token-to-role mapping may be used to resolve roles for the first time-to-live period. As explained further below, certain requests may refresh the cache.

After resolving the role(s), the playback device 102n may next attempt to resolve permissions. At 1065j, the playback device 102n checks a role-to-permission cache. For instance, the playback device 102n may determine whether the edge data cache 760 includes or excludes a role-to-permission mapping corresponding to the first token (e.g., in the role-to-permission mappings 761b) (FIG. 7). Based on determining that the edge data cache 760 excludes a token-to-role mapping corresponding to the first role (i.e., a cache miss), the playback device 102n goes to the cloud to attempt to resolve the permissions.

In particular, at 1065k, the play back device 102n sends a request to the authentication services 710b-2 to resolve the permissions. As illustrated in FIG. 10A, the request includes an indication of the first role. The request may take the form of a HTTP GET request. An example GET request to resolve permissions is shown as follows:

GET /authz/v1/policy
/8dLSSTphqyG_
fezbJS83zK-
7BU HTTP/1.1
. . .

As shown, the HTTP GET request includes the policy Key as an indication of the resolved role.

Within examples, determining the role-to-permission mapping for the first role may involve querying a database or other data storage structure for a permission set matching the role. Such a query may return an indication of the permission set corresponding to the role. An indication of such permissions may be ultimately provided to the playback device 102n in a response.

At 10651, the authentication service 710b-2 sends a response to the request to resolve permissions. The response includes an indication of the permissions set corresponding to the first role. In this example, the permissions set in in the form of a permissions mask. The response also includes an indication of a second time-to-live period (TTL2), which indicates how long the permissions mask for the first role remains valid. An example successful response is shown as follows:

```
HTTP/1.1 200 OK
Cache-Control: public, max-age=86400, stale-while-
revalidate=43200, stale-if-error=43200
ETag: 6ccceca3640bf81ale10135e3d286b8c
Content-Type: application/json
. . .
[
  { “namespace”: “groupVolume”, “permissions”: 3},
  { “namespace”: “playback”, “permissions”: 5},
  { “namespace”: “playbackMetadata”, “permissions”: 1} ,
  { “namespace”: “volume”, “permissions”: 3},
  { “namespace”″: “playlist”, “permissions”: 7},
  // ...
]
```

As shown, the response includes a map of namespaces to permissions bitmasks. Here the integers in the mask represent permissions for different types of commands within a namespace, similar to a Unix permissions mask.

More particularly, a namespace may define a bit-position-to-permission order within the bitmask. For instance, a “playlist” namespace (including playlist resources) may define a bit-position-to-permission as “create,” “read,” “update,” “delete” and “load” permissions corresponding to the least significant bit to the most significant bit, respectively. An HTTP example is as follows:

```
<muse-namespace name=″playlists″
>
  <!-- . . . -- >
  <permissions>
    <! -- Least-significant bit
-- >
    <permission name=“CREATE”/>
    <permission name=“READ”/>
    <permission name=“UPDATE”/>
    <permission name=“DELETE”/>
    <permission name=“LOAD”/>
    <! -- Most-significant bit --
>
  </permissions>
</muse-namespace>
```

In this example, a permissions mask of “18” represents permissions to READ and LOAD, but not to CREATE, UPDATE, or DELETE. Such permission as represented as follows:

18 (dec) 10010 (bin)
0 (LSB) PLAYLIST::CREATE
1 PLAYLIST::READ
0 PLAYLIST::UPDATE
0 PLAYLIST::DELETE
1 (MSB) PLAYLIST::LOAD

As another example, a permissions mask of “31” (or “11111” in binary) in the “playlist” namespace represents permissions to CREATE, READ, UPDATE, DELETE, and LOAD, which would be representative of full (e.g., owner or administrator) permissions.

The HTTP header of the response also includes information to facilitate caching. In particular, the header indicates the second time-to-live period, which in this example is 86400 seconds. The header also includes an ETag to identify the particular version of the resource (e.g., the permissions mask). As explained in further detail below, the ETag may be used to determine whether the permissions mask has been changed (and thus needs to be re-requested from the authentication service 710b-2).

In some implementations, role resolution and permissions resolution are intentionally separated into separate requests, as they have different usage patterns and requirements. To facilitate quick revocation of access (e.g., of guests), a subject-to-role mapping may have a relatively short time-to-live in the edge data cache 760. In contrast, a role-to-permissions map is less likely to change frequently and so may be cached for a longer period. To illustrate, the example first time-to-live period for the token-to-role mapping is much shorter (300 seconds) than the example second time-to-live period for the role-to-permissions mapping (86400 seconds).

Each token-to-role mapping is unique to each client, whereas many clients may have the same role, which maps to the same permissions. As such, in certain usage scenarios, such as a house party, retail, or hospitality business, there may be many clients with unique tokens but the same role. As such, as unique guests come and go, the role-to-permissions mappings in the edge data cache 760 may be hit relatively more often (e.g., for the same guest role) as compared with the token-to-role mappings. As such, in at least these usage patterns, caching role-to-permissions mappings may avoid relatively more server requests as compared with the token-to-role mappings. Some implementations might not utilize token-to-role mappings and instead rely only on role-to-permissions mappings as cache hits are less likely in the token-to-role mappings.

At 1065m, the play back device 102n caches the role-to-permissions mapping in the edge data cache 760 (e.g., in the role-to-permissions mappings 761b). In some examples, the caching is maintained for the second time-to-live period and removed from the cache when this period expires. In other examples, the caching is considered valid for the second time-to-live period (and can't be used to resolve permissions after invalidated as it is considered stale). In either case, the cached role-to-permissions mapping may be used to resolve roles for the second time-to-live period. Like other cached data, some types of requests may refresh this cached data.

Once the playback device 102n has the permissions set, the playback device 102n may determine whether to accept or reject the command. That is, the playback device 102n may determine that the command is permitted by the resolved permission set and carry out the command at 1065n. Conversely, the playback device 102n may determine that the command is prohibited by the resolved permission set and not carry out the command.

To illustrate, following the above example, when the command attempts to read or modify a resource in a given namespace (e.g., is a command to change volume in a “volume” namespace), the playback device 102n may determine whether the bitmask integer for that namespace in the permissions mask allows that client to modify volume on that object (i.e., the play back device 102n). If the command is permitted, the command is carried out.

When the play back device 102n is in a group (e.g., a zone group (FIG. 3E) or a bonded zone (FIGS. 3A-3D), the command may operate on multiple play back devices (e.g., all playback devices in the group. For instance, a command modifying the “play back” namespace may change playback on all playback devices 102 in a group. However, some commands might operate individually. For instance, a command modifying the “volume” namespace may change volume an individual playback device 102 (as compared with a command modifying the “groupVolume” namespace, which may modify the volume of the group as a whole).

Within examples, at 1065o, the playback device 102n may provide a command result to the control device 104a. The command result indicates whether the command was carried out and may also indicate current resource states following the command (which may be updated if the command modified the resource). For instance, if the volume resource was modified to a different volume level, the command result may indicate the new volume level.

When receiving the command result, the control device 104a may update a user interface (e.g., the control interfaces 540) to indicate the result of the command. For instance, if the command was carried out, a control corresponding to the corresponding resource (e.g., a volume slider) may be updated to indicate the modified volume level. If the command was not carried out, an indication of this result may be explicitly indicated (e.g., by graying out or otherwise modifying an associated control, or an explicit message indicating that the user cannot perform this command).

FIG. 10B is another message flow diagram illustrating data exchanges between devices shown the architecture 700. The message flow diagram of FIG. 10B represents a message flow that may occur after a client is authenticated and mappings are cached in the edge data cache 760. Further, in this example, the control device 104a already has a valid token (e.g., the first token of the FIG. 10A example).

At 1066a, the control device 104a sends a command to the play back device 102n. Before performing a restricted action (e.g., via the command), the client authenticates with the playback device 102n. As shown in FIG. 7A, the command includes the first token, which as noted above may be used to authenticate the client with the playback device 102n.

After receiving such a command, the play back device 102n attempts to resolve the role(s). In particular, at 1066b, the playback device 102n checks a token-to-role cache. For instance, the playback device 102n may determine whether the edge data cache 760 includes or excludes a token-to-role mapping corresponding to the first token (e.g., in the token-to-role mappings 761a) (FIG. 7). Based on determining that the edge data cache 760 includes a token-to-role mapping corresponding to the first token (i.e., a cache hit), the playback device 102n resolves the role using the cached token-to-role mapping. Continuing the FIG. 10A example, using the cached token-to-role mapping, the play back device 102n may resolve the first token to the first role (e.g., as indicated by the policy Key) resolved in the FIG. 10A example.

After resolving the roles, the playback device 102n attempts to resolve the permissions set corresponding to the first role. At 1066c, the play back device 102n checks the role-to-permissions cache. For instance, the playback device 102n may determine whether the edge data cache 760 includes or excludes a role-to-permissions mapping corresponding to the first role (e.g., in the role-to-permissions mappings 761b) (FIG. 7). Based on determining that the edge data cache 760 includes a role-to-permissions mapping corresponding to the first role (i.e., a cache hit), the playback device 102n resolves the permissions set using the cached role-to-permissions mapping. Continuing the FIG. 10A example, using the cached token-to-role mapping, the play back device 102n may resolve the first role to the first permissions set (e.g., as indicated by the permission mask) resolved in the FIG. 10A example.

Similar to the FIG. 10A example, after resolving the permissions set, the play back device 102n may determine whether to accept or reject the command. That is, the play back device 102n may determine that the command is permitted by the resolved permission set and carry out the command at 1066d. Conversely, the playback device 102n may determine that the command is prohibited by the resolved permission set and not carry out the command.

At 1066e, the play back device 102n may provide a command result to the control device 104a. The command result indicates whether the command was carried out and may also indicate current resource states following the command (which may be updated if the command modified the resource). When receiving the command result, the control device 104a may update a user interface (e.g., the control interfaces 540) to indicate the result of the command.

In some cases, the edge data cache 760 includes a mapping but the cached data is stale. For instance, the role-to-permission cache may include a role-to-permission mapping corresponding to the first role, but the corresponding second time-to-live period is expired, thereby indicating that the cached data is stale. In such cases, the playback device 102n may send a conditional request (e.g., an HTTP request with an if-modified-since HTTP header) indicating the ETag of the cached role-to-permission mapping.

If the role-to-permission mapping has not changed (as indicated by the ETag of the cached role-to-permission mapping matching the ETag of the role-to-permission mapping at the authentication service 710b-2, the authentication service 710b-2 can respond with a particular status (e.g., 200 status) indicating that the cached data is still the same. Here, the authentication service 710b-2 does not have to send the body (including the permission mask) and instead sends only the header, thereby minimizing data transmission traffic and accordingly saving on data transmission costs.

To illustrate, FIG. 10C is another message flow diagram illustrating data exchanges between devices shown in architecture 700 to perform authorization of another client (the control device 104b) (FIG. 7). The message flow diagram begins with authenticating a client. At 1067a, the control device 104b sends authentication credentials to the authentication service 710b-1. The authentication service 710b-1 determines whether the authentication credentials are valid, and if so, sends a token to the control device 104b at 1067b. This token is referred to in this example as a second token.

At 1067c, the control device 104a sends a command to the play back device 102n. Before performing a restricted action (e.g., via the command), the client authenticates with the play back device 102n. Here, the command includes the second token. Like the first token, the second token may be referenced in a header (e.g., an HTTP header) possibly along with other information to facilitate the command. This second token may be used to authenticate the second client with the play back device 102n.

After receiving such a command, the play back device 102n attempts to resolve the role(s). In particular, at 1067d, the playback device 102n checks the token-to-role cache. For instance, the playback device 102n may determine whether the edge data cache 760 includes or excludes a token-to-role mapping corresponding to the second token (e.g., in the token-to-role mappings 761a) (FIG. 7). Based on determining that the edge data cache 760 excludes a token-to-role mapping corresponding to the second token (i.e., a cache miss), the play back device 102n goes to the cloud to attempt to resolve the roles.

In particular, at 1067e, the playback device 102n sends a request for a role corresponding to the second token to the authentication service 710b-2. As illustrated in FIG. 10C, the request includes indications of the second token, the object (e.g., the media playback system 100, or the play back device 102n, depending on scope), and any modifications. The request may take the form of a HTTP POST request with the indications carried in a header.

At 1067f, the authentication service 710b-2 sends a request to validate the second token to the authentication service 710b-1. Then, at 1067g, the authentication service 710b-1 replies with a validation result. If the second token is valid, the validation result indicates that the second token is valid and also provides an indication of the first time-to-live period (denoted as “TTL1”). Note that this first time-to-live period may be the same duration as the first time-to-live period for the first token (or may be set differently, perhaps based on the type of client). For instance, a token for a client that has third-party software may be validated a different (e.g., shorter) time-to-live period.

When the validation result is successful, the authentication service 710b-2 determines the token-to-role mapping for the second token. As explained above, the authentication service 710b-2 maintains or has access to token-to-role mappings for each token. Within examples, determining the token-to-role mapping for the second token may involve querying a database or other data storage structure for a role matching the object and the second token. Such a query may return an indication of the role(s) corresponding to the second token on the object. An indication of such roles may be ultimately provided to the play back device 102n in a response.

At 1067h, the authentication service 710b-2 sends a response to the playback device 102n. If the second token is valid, the response will indicate a success and the resolved role mapping. In this example, the resolved role corresponding to the second token is referred to as a second role.

At 1067i, the playback device 102n caches the token-to-role mapping in the edge data cache 760 (e.g., in the token-to-role mapping 761a). In some examples, the caching is considered stale after expiration of the first time-to-live period. If the cache is stale, the cached data cannot be used unless a conditional request to the authentication service 710b-2 (e.g., an if-modified-since HTTP request) indicates that the cached data is still up-to-date.

After resolving the role(s), the playback device 102n next attempts to resolve permissions. At 1067j, the play back device 102n checks a role-to-permission cache. For instance, the play back device 102n may determine whether the edge data cache 760 includes or excludes a role-to-permission mapping corresponding to the second token (e.g., in the role-to-permission mappings 761b) (FIG. 7). Based on determining that the edge data cache 760 includes a token-to-role mapping corresponding to the second role (i.e., a cache hit) but that the cached data is stale (e.g., because a time-to-live period has expired), the playback device 102n goes to the cloud to attempt to resolve the permissions.

In particular, at 1067k, the play back device 102n sends a conditional request to the authentication services 710b-2 to resolve the permissions. As illustrated in FIG. 10A, the request includes an indication of the second role and an indication of a version of the cached role-to-permission mapping corresponding to the second role. The request may take the form of a HTTP if-modified-since request including an ETag indicating the cached version.

When receiving such a request, the authentication service 710b-2 may determine whether the stale cached version of the role-to-permission mapping is still up-to-date. The authentication service 710b-2 may make such a determination by comparing the ETag of the cached version of the role-to-permission mapping with an ETag of the version of the role-to-permission mapping at the authentication service 710b-2. As noted above, the ETags act as a fingerprint of the version. If the ETags match, no change has been made to the role-to-permission mapping. If the ETags are different, the version of the role-to-permission mapping at the authentication service 710b-2 has changed and authentication service 710b-2 responds to the request with the new mappings.

However, when the ETags match, the authentication service 710b-2 can avoid sending the mappings and can instead respond only with an indication that the cached data previously considered stale is still valid. Such a response may take the form of an HTTP status (e.g., 200 OK) and no body (as the mappings themselves are not necessary). To illustrate, at 10671, the authentication service 710b-2 sends a response to the request to resolve permissions indicating a status (e.g., 200 OK) and an indication of a third time-to-live period (TTL3), which indicates how long the permissions mask for the first role remains valid. In some examples, this time-to-live period may be the same length of time as the second time-to-live period.

At 1067m, the playback device 102n re-caches the role-to-permissions mapping in the edge data cache 760 (e.g., in the role-to-permissions mappings 761b). As noted above, in some examples, the caching is maintained for the second time-to-live period and considered expired after the second time-to-live period. In other examples, the caching is removed from the cache after the second time-to-live period. In either case, the cached role-to-permissions mapping may be used to resolve roles for the second time-to-live period.

Once the playback device 102n has the permissions set, the playback device 102n may determine whether to accept or reject the command. That is, the playback device 102n may determine that the command is permitted by the resolved permission set and carry out the command at 1067n. Conversely, the playback device 102n may determine that the command is prohibited by the resolved permission set and not carry out the command.

Within examples, at 10670, the playback device 102n may provide a command result to the control device 104b. The command result indicates whether the command was carried out and may also indicate current resource states following the command (which may be updated if the command modified the resource). When receiving the command result, the control device 104b may update a user interface to indicate the result of the command.

In traditional HTTP caching, a client (e.g., a web browser) caches data from a web server. In contrast, while the example authentication management may utilize features of HTTP caching during authentication management, the play back device 102 including the cache (e.g., the play back device 102n) is caching data on itself to respond to commands (which may take the form of HTTP requests) from one or more clients. That is, as illustrated in FIGS. 10B and 10C, the play back device 102n may act as an edge server itself to avoid calls to cloud services such as the authentication service 710b-1 and the authentication service 710b-2. In other words, the play back device 102 operates as a hybrid client and server within the architecture 700.

In some cases, the playback devices 102 may support two or more different types of commands. For instance, the play back devices 102 may support a legacy API (e.g., universal plug- and play) and a platform API. As another example, the playback devices may support platform API and one or more third-party (APIs), such as Airplay® or Spotify Connect®.

In such examples, the play back devices 102 may receive a first command according to a first API (e.g., a third party or legacy API) and map the first command to a corresponding command in another API (e.g., the platform API). After mapping, the play back devices 102 may determine whether the corresponding command is permitted by the permission set. Such an implementation may avoid having to implement permissions sets for all supported APIs.

In some instances, the first command according to the first API may map to two or more second commands in the second API. In such examples, determine whether the first command is permitted by a permission set may involve determining whether each of the two or more second commands are permitted. For instance, a playback command targeting two or more playback devices in the first API may map to a grouping command and a group play back command in the second API. Many other examples are possible.

To provide further illustration, FIGS. 9A-9C are functional block diagrams showing examples in the example architecture 700 (FIG. 7). Such examples are intended to be representative of authentication management with various clients. Such techniques may be applied using different architectures and clients.

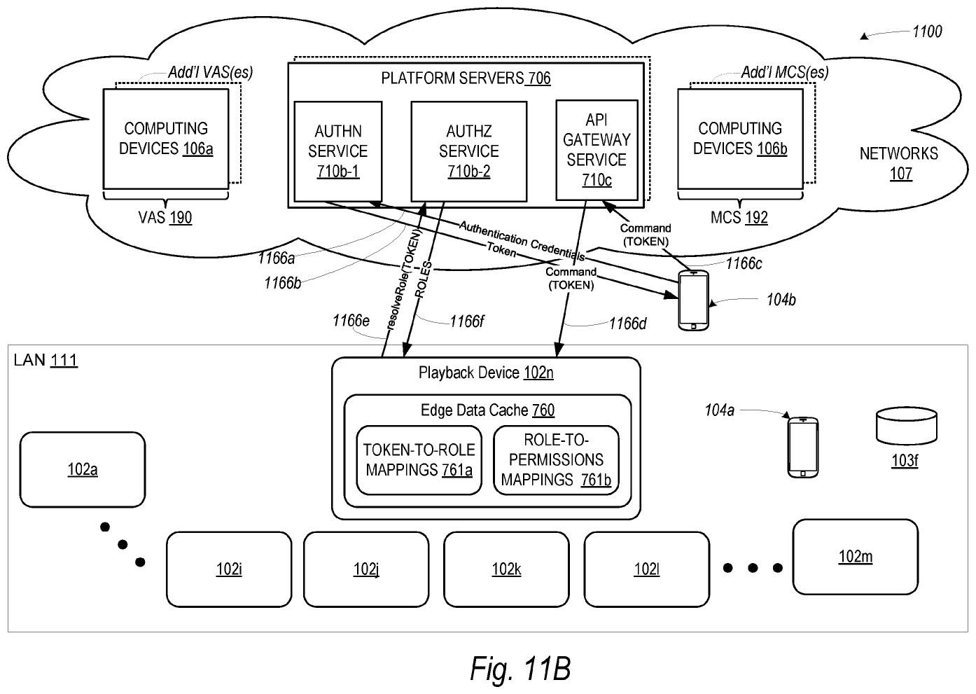

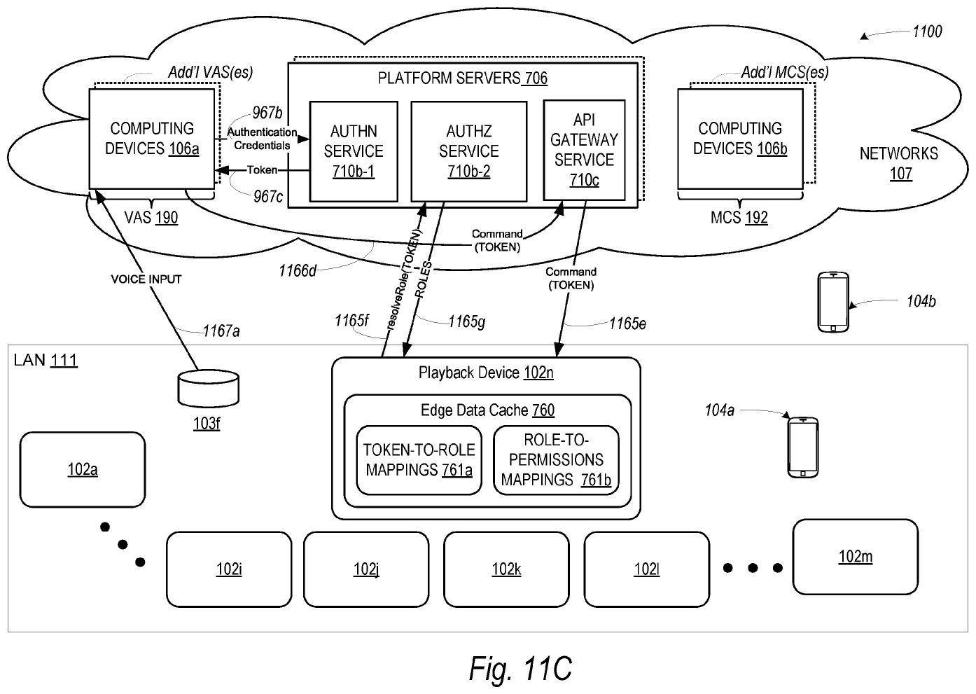

FIG. 11A shows an architecture 1100, which is a variation on the architecture 700. In this example, the platform service 710a is not shown (for simplification, but may still be considered to exist) and the authentication services 710b are illustrated as the first authentication service 710b-2 (or the AuthN service 710b-1) and authentication service 710b-2 (or the AuthZ service 710b-2). Notably, the architectures 700 and 1100 are illustrative architectures to illustrate examples: various implementations may utilize architectures with different combinations of devices.

FIG. 11A illustrates an authenticating a new client (the control device 104a) that is located on the LAN 111, which is similar to the FIG. 10A example. At 1165a, the control device 104a sends authentication credentials to the authentication service 710b-1. The authentication service 710b-1 determines whether the authentication credentials are valid, and if so, sends a token to the control device 104a at 1165b.

At 1165c, the control device 104a sends a command to the playback device 102n via the LAN 111. The command indicates the token. As noted above, the command may take the form of an HTTP request with a header indicating the token.

After receiving the command, the play back device 102n attempts to resolve the role corresponding to the token. At 1165d, the playback device 102n sends a request for a role corresponding to the token to the authentication service 710b-2. The authentication service 710b-2 determines the token-to-role mapping for the token. As explained above, the authentication service 710b-2 maintains or has access to token-to-role mappings for each token. Within examples, determining the token-to-role mapping for the second token may involve querying a database or other data storage structure for a role matching the object and the token. At 1165d, the authentication service 710b-2 sends a response to the playback device 102n. If the token is valid, the response will indicate a success and the resolved role mapping.

After resolving the role, the playback device 102n next attempts to resolve permissions. At 1165f, the playback device 102n sends a request to resolve permissions to the authentication service 710b-2. The request indicates the role. The authentication service 710b-2 resolves the permission set corresponding to the role. At 1165g, the authentication service 710b-2 sends a response indicating the permission set (as a permission mask).

Once the playback device 102n has the permissions set, the playback device 102n may determine whether to accept or reject the command. That is, the playback device 102n may determine that the command is permitted by the resolved permission set and carry out the command. For instance, the playback device 102n may read or modify a particular namespace of the platform API. Conversely, the playback device 102n may determine that the command is prohibited by the resolved permission set and not carry out the command.

In some cases, the command targets other or additional playback devices 102 in the media playback system. For instance, the command may target the play back devices 102k and 102l (and perhaps not the play back device 102, which may act as a point-of-contact for the control device 104a). In such examples, carrying out the command may involve causing the targeted playback devices 102k and 102l to carry out the command. For instance, at 1165h and 1165i, the play back device 102 may event changes to the particular namespace over the LAN 111 to the play back devices 102k and 102l, respectively, which cause the play back devices 102k and 102l to carry out the command.

A command result may be sent back to the control device 104a. To illustrate, at 1165j, the playback device 102n sends a command result. Alternatively, one or both of the play back devices 102k and 102l may send back a command result.

FIG. 11B is an example of authenticating a new client (the control device 104b) that is not located on the LAN 111 but instead connected to the media playback system 100 via a wide area network. At 1166a, the control device 104b sends authentication credentials to the authentication service 710b-1. The authentication service 710b-1 determines whether the authentication credentials are valid, and if so, sends a token to the control device 104b at 1166b.

At 1166c, the control device 104b sends a command to the playback device 102n via an API gateway 710c. The API gateway 710c provides a point-of-contact outside of the LAN 111 for clients over the WAN. At 1166d, the API gateway 710c sends the command including the token to the playback device 102n.

After receiving the command, the play back device 102n attempts to resolve the role corresponding to the token. At 1166e, the playback device 102n sends a request for a role corresponding to the token to the authentication service 710b-2. The authentication service 710b-2 determines the token-to-role mapping for the token. At 1166f, the authentication service 710b-2 sends a response to the playback device 102n. If the token is valid, the response will indicate a success and the resolved role mapping.

After resolving the role, the playback device 102n next attempts to resolve permissions. In this example, the role-to-permission caching is cached in the edge data cache 760. As such, the play back device 102n can resolve the permission set without communicating again with the authentication service 710b-2.

Once the play back device 102n has resolved the permissions set, the play back device 102n may determine whether to accept or reject the command. That is, the playback device 102n may determine that the command is permitted by the resolved permission set and carry out the command. Conversely, the playback device 102n may determine that the command is prohibited by the resolved permission set and not carry out the command.

FIG. 11C is an example of authenticating a new client (the NMD 103f) that is located on the LAN 111 but includes third-party software (e.g., to process voice inputs via the VAS 190). At 1167a, the NMD 103f sends a voice input to the computing devices 106a. At 1167b, the computing devices 106a sends authentication credentials to the authentication service 710b-1. The authentication service 710b-1 determines whether the authentication credentials are valid, and if so, sends a token to the computing devices 106a at 1167c.

At 1167d, the computing devices 106a send a command to the play back device 102n via the API gateway 710c. As noted above, the API gateway 710c provides a point-of-contact outside of the LAN 111 for clients over the WAN. At 1167e, the API gateway 710c sends the command including the token to the play back device 102n.

After receiving the command, the play back device 102n attempts to resolve the role corresponding to the token. At 1167f, the playback device 102n sends a request for a role corresponding to the token to the authentication service 710b-2. The authentication service 710b-2 determines the token-to-role mapping for the token. At 1167g, the authentication service 710b-2 sends a response to the play back device 102n. If the token is valid, the response will indicate a success and the resolved role mapping.

After resolving the role, the playback device 102n next attempts to resolve permissions. In this example, the role-to-permission caching is cached in the edge data cache 760. As such, the play back device 102n can resolve the permission set without communicating again with the authentication service 710b-2.

Once the play back device 102n has resolved the permissions set, the play back device 102n may determine whether to accept or reject the command. That is, the playback device 102n may determine that the command is permitted by the resolved permission set and carry out the command. Conversely, the playback device 102n may determine that the command is prohibited by the resolved permission set and not carry out the command.

In addition to the services 710, the playback devices 102 may also (or alternatively) authenticate with the media content services 106b (FIG. 1B). Such authentication may involve sending a media content services 106b authentication credentials, which may be in the form of a token that the control device 104a already has stored as a result of previously registering using another form of credentials (e.g., username and password) using the control device 104a. For instance, the authentication credentials may be in the form of a token from a streaming audio service, which the control device 104a has registered with for playback using the control device 104a. Example authentication is described in U.S. patent application Ser. No. 13/630,616, filed on Sep. 28, 2012, titled “Assisted Registration of Audio Sources,” and issued as U.S. Pat. No. 8,910,265 on Dec. 9, 2014, which is herein incorporated by reference in its entirety. Further example authentication is described in U.S. patent application Ser. No. 14/330,754, filed on Jul. 14, 2014, titled “Managing Application Access of A Media Playback System,” and issued as U.S. Pat. No. 10,498,833 on Dec. 3, 2019, which is herein incorporated by reference in its entirety. Yet additional example authentication is described in U.S. patent application Ser. No. 14/606,162, filed on Jan. 27, 2015, titled “Sharing Access To A Media Service,” and issued as U.S. Pat. No. 9,876,780 on Jan. 23, 2018, which is herein incorporated by reference in its entirety.

While examples described above involve caching on the playback devices 102, in some examples, similar techniques may be applied to caching on other devices on the LAN 111, such as the control devices 104, the NMDs 103, and/or other IoT devices. One reason to cache on the play back devices 102 is that, in typical usage, it is more likely that at least one play back device is available on the LAN 111, as users tend to take mobile and other computing devices that operate as control devices with them when they leave their home, business, or other location of the media playback system. In other words, in example media playback systems with variable numbers of playback devices 102 and control devices 104, it is more likely that at least one of the play back devices 102 is available. Another reason to implement caching on the playback devices 102 is to simplify implementation of third-party controllers, as a playback device 102 may provide a more consistent gateway to integrate with relative to other devices on the LAN 111.

On the other hand, some instances of the media play back system 100 may have only portable playback devices. Such playback devices might not be considered to be as likely to be available on the LAN 111, as various users within a household may take them off the LAN 111 and or turn them off to conserve battery charge. In such cases, the control devices 104 may be considered as likely to be available as the playback devices 102, which may support caching on the control devices 104 (perhaps one or more particular control devices, e.g., with high availability) or another device altogether.

As noted above, in some cases, the media playback system 100 may cache on multiple devices. For instance, system 100 may cache on one or more devices that operate as a gateway play back device and also on one or more portable playback devices 102. In one example, the data cached on a portable playback device 102 may be intentionally tailored to that portable play back device 102 to enable continuity of use of that device while on-the-go. On the other hand, the data cached on gateway playback device may include data for multiple devices on the LAN 111.

### V. Example Methods

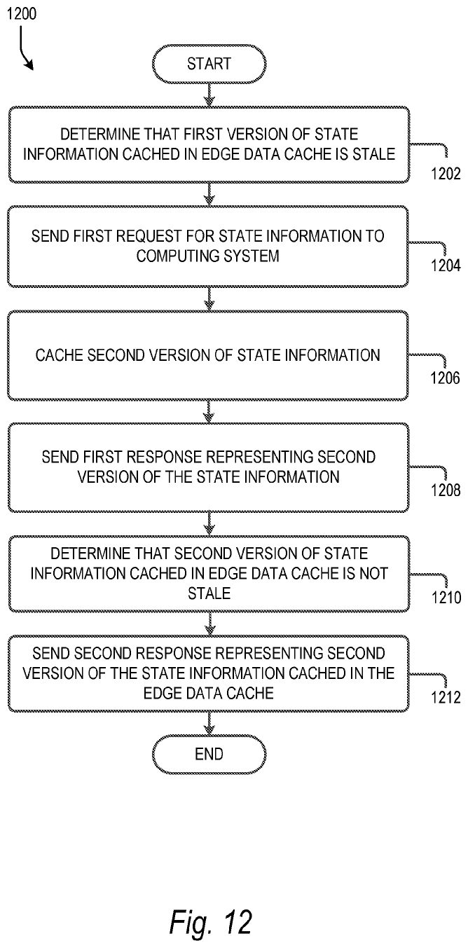

FIG. 12 is a flow diagram showing an example method 1200 to edge data cache. The method 1200 may be performed by one or more playback device(s) 102. Alternatively, the method 1300 may be performed by any suitable device or by a system of devices, such as the playback devices 102, the NMDs 103, control devices 104, computing devices 105, computing devices 106, or by smart IoT devices (such as the smart illumination device 108 or smart thermostat 110). For the purposes of illustration, certain features are described as being performed by the play back device 102n and/or the platform servers 706 (FIG. 7).

At block 1202, the method 1200 involves determining that a first version of state information cached in the edge data cache is stale. For instance, the playback device 102n may determine that a data resource representing state information (e.g., playback history information, settings, etc.) corresponding to the playback device 102n (or another playback device 102n) is stale. In some examples, determine that a version of state information cached in the edge data cache is stale may involve determining that a time-to-live period for the version of the state information cached in the edge data cache has expired. Further details and other example determinations are described in connection with FIGS. 7, 8A, 8B, and 10A-10C, as well as elsewhere throughout the disclosure.

Various operations may trigger determining whether state information cached in an edge data cache is stale. In some cases, the playback device 102n may determine whether state information is stale based on receiving a request for the state information from a client device, as illustrated in FIGS. 8A and 8B. In other cases, the playback device 102n may make such a determination based on receiving a notification that a new version of the state information is available. In further examples, the playback device 102n may trigger such a determination itself, perhaps when one or more conditions are satisfied (e.g., expiration of a time-to-live period or a change in the state information that would supersede the cached state information).

At block 1204, the method 1200 involves sending data representing a first request for the state information to a computing system. For instance, based on determining that the first version of the state information cached in the edge data cache is stale, the play back device 102n may send, via a network interface, data representing a first request for the state information to the platform servers 706. As noted above, the platform servers 706 may operate as a “source-of-truth” for state information representing states within the media playback system 100. As such, by requesting the state information from the platform servers, the playback device 102n may retrieve a version of the state information that is considered up-to-date and accurate relative to other versions stored elsewhere within the media playback system 100. Example requests for state information and other cacheable data are described in connection with FIGS. 7, 8A, 8B, and 10A-10C, as well as elsewhere throughout the disclosure.

At block 1206, the method 1200 involves caching a second version of the state information in the edge data cache. For example, after receipt of data representing a second version of the state information from the platform servers 706, the play back device 102n may cache the second version of the state information in the edge data cache 760 (FIG. 7). Example edge data caching is described in connection with FIGS. 7, 8A, 8B, and 10A-10C, as well as elsewhere throughout the disclosure.

At block 1208, the method 1200 involves sending a first response representing a second version of the state information. For instance, the play back device 102n may send the first response representing the second version of the state information to a client device, such as a control device 104, a playback device 102, or another network device. The playback device 102n may send the first response based on receiving a request for the state information from the client device, or based on a different trigger, such as determining that the state information is stale. Example responses are described in connection with FIGS. 7, 8A, 8B, and 10A-10C, as well as elsewhere throughout the disclosure.

At block 1210, the method 1200 involves determining that the second version of state information cached in the edge data cache is not stale. For instance, the play back device 102n may determine that a data resource representing the second version of the state information is not stale, perhaps because a time-to-live period has not expired and/or because the playback device 102n has not been otherwise notified that the second version of state information cached in the edge data cache has become stale, among other examples.

Similar to the determination in block 1202, various operations may trigger determining whether state information cached in an edge data cache is stale. In some cases, the playback device 102n may determine whether state information is stale based on receiving a second request for the state information from the client device, or based on receiving a request for the state information from another client device. Alternatively, the playback device 102n may make such a determination based on receiving a notification that a new version of the state information is available. In further examples, the playback device 102n may trigger such a determination itself, perhaps when one or more conditions are satisfied (e.g., expiration of a time-to-live period or a change in the state information that would supersede the cached state information).

At block 1212, the method 1200 involves sending a second response representing the second version of the state information. For instance, the playback device 102n may send the second response representing the second version of the state information to a client device, such as a control device 104, a playback device 102, or another network device. As noted above, the client device may be the same client device that sent the first request, or it may be a different client that is requesting the same resource. The play back device 102n may send the first response based on receiving a request for the state information from the client device, or based on a different trigger, such as determining that the state information is stale. Example responses are described in connection with FIGS. 7, 8A, 8B, and 10A-10C, as well as elsewhere throughout the disclosure.

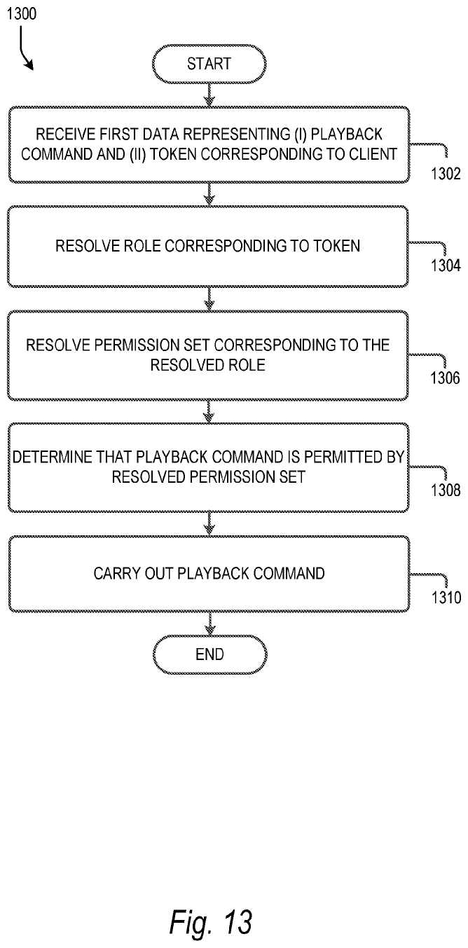

FIG. 13 is a flow diagram showing an example method 1300 to authenticate a client and carry out a restricted command. The method 1300 may be performed by one or more play back device(s) 102. Alternatively, the method 1300 may be performed by any suitable device or by a system of devices, such as the playback devices 102, the NMDs 103, control devices 104, computing devices 105, computing devices 106, or by smart IoT devices (such as the smart illumination device 108 or smart thermostat 110). For the purposes of illustration, certain features are described as being performed by the playback device 102n and/or the platform servers 706 (FIG. 7).

At block 1302, the method 1300 involves (i) receiving data representing a play back command and (ii) a token corresponding to a client. For example, the play back device 102n may receive, via a first network interface, first data representing (i) a first play back command and (ii) a first token corresponding to a first client, such as the control device 104a (FIGS. 7, 10A-10B). In some cases, the first client and the play back device are connected to a local area network (FIG. 11A). In other cases, clients are not connected to the local area network (e.g., FIG. 11B).

At block 1304, the method 1300 involves resolving a role corresponding to the token. For example, the playback device 102n and the authentication service 710b-2 may resolve a first role corresponding to the first token (FIG. 10A) based on a role-to-token mapping. Alternatively, the playback device 102n may resolve a first role corresponding to the first token using an edge data cache (FIG. 10B). Within examples, the play back device 102n may cache, in the edge data cache, the first token-to-role mapping that maps the first token to the first role (FIGS. 10A and 10C).

In an example, the playback device 102n may determine that an edge data cache (e.g., the edge data cache 760) excludes a token-to-role mapping corresponding to the first token (e.g., 1065d in FIG. 10A). The playback device 102n may send, via the first network interface to the computing system, a request for a role corresponding to the first token (e.g., 1065e in FIG. 10A). The platform servers 706 may receive, via a second network interface, the request for the role corresponding to the first token and determine, based on stored role-to-token mappings for a plurality of media playback systems, a first token-to-role mapping that maps the first token to a first role for the media play back system (FIG. 10A). The platform servers 706 may send, via the second network interface to the playback device, data representing the first token-to-role mapping for the media playback system and the playback device 102n may receive, via the network interface, a response to the request indicating the first token-to-role mapping that maps the first token to the first role (e.g., 1065h in FIG. 10A).

In another example, the playback device 102n may determine that an edge data cache (e.g., the edge data cache 760) includes a token-to-role mapping corresponding to the first token (e.g., 1066b in FIG. 10B). In such an example, the play back device 102n may resolve the first role based on the edge data cache (e.g., based on a cached token-to-role mapping in the edge data cache 760). In a further example, when cached data in the edge data cache is stale, the play back device 102n may resolve the first role based on a conditional request (FIG. 10C).

At block 1306, the method 1300 involves resolving the permission set corresponding to the resolved role. For example, the playback device 102n and the authentication service 710b-2 may resolve a first permission set corresponding to the first role (FIG. 10A) based on a role-to-permission mapping. Alternatively, the playback device 102n may resolve the first permission set corresponding to the first role using an edge data cache (FIG. 10B). The permission set may be represented as a permission mask.

In an example, the playback device 102m may determine that the edge data cache includes a first role-to-permission mapping corresponding to the first role (e.g., 1066c in FIG. 10B) The first role-to-permission mapping maps the first role to a first permission set. As such, the playback device 102 may resolve the first permission set using the cached first role-to-permission mapping.

In another example, the playback device 102n may determine that the edge data cache excludes a role-to-permission mapping corresponding to the first token (e.g., 1065j in FIG. 10A). The playback device 102n may send, via the first network interface to the computing system, a request for a permission set corresponding to the first role (e.g., 1065k in FIG. 10A). The platform servers 706 may receive, via a second network interface, the request for the permission set corresponding to the first token and determine, based on stored role-to-permission mappings for a plurality of media play back systems, a first role-to-permission mapping that maps the first role to a first permission set for the media play back system (FIG. 10A). The platform servers 706 may send, via the second network interface to the play back device, data representing the first role-to-permission mapping for the media play back system and the play back device 102n may receive, via the network interface, a response to the request indicating the first role-to-permission mapping (e.g., 10651 in FIG. 10A).

At block 1308, the method 1300 involves determining that the play back command is permitted by the resolved permission set. For instance, the playback device 102n may determine that the play back command is permitted based on a namespace of a resource being created, read, deleted, modified, or otherwise referenced and a portion of a bitmask indicating permission (or not) for that action (FIG. 10A). Other examples are possible as well.

At block 1310, the method 1300 involves carrying out the playback command. In some examples, the play back device 102n may carry out the play back command on itself. In other examples, such as when the playback device 102n is in a group or different play back devices are targeted (FIG. 11A), the play back device 102n may carry out the play back command on the group or on the targeted play back devices.

In further examples, the method 100 involves caching in an edge data cache (e.g., the edge data cache 760). For instance, the playback device 102n may cache, in the edge data cache, the token-to-role mappings that maps tokens to the corresponding roles (FIG. 9A). As another example, the play back device 102n may cache, in the edge data cache, permission-to-role mappings that map the permissions to the corresponding roles (FIG. 9A).

In further examples, the method 1300 involves authenticating additional clients and carrying out additional commands from such clients. Further variations and functions that may be performed as part of the method 1300 are described throughout this disclosure, including in the foregoing sections I, II, and III.

### CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

Example 1: A method to be performed in a system comprising a play back device, the method comprising: determining that a first version of state information corresponding to the play back device cached in the edge data cache is stale, wherein the playback device is connected to a local area network (LAN): after determining that the first version of the state information cached in the edge data cache is stale, sending, via a network interface to a computing system, data representing a first request for the state information corresponding to the playback device, wherein the computing system is outside of the LAN: after receiving data representing a second version of the state information corresponding to the play back device, caching, in the edge data cache, the second version of the state information of the state information corresponding to the playback device: sending, via the network interface to a network device, a first response comprising first data representing the second version of the state information: determining that the second version of the state information corresponding to the play back device cached in the edge data cache is not stale; and after determining that the second version of the state information cached in the edge data cache is not stale, sending, via the network interface, a second response comprising second data representing the second version of the state information cached in the edge data cache.

Example 2: The method of Example 1, further comprising: receiving, via the network interface, a first request for state information corresponding to the play back device, wherein the playback device is configured to determine whether the first version of the state information cached in the edge data cache is stale after receipt of the first request for state information; and receiving, via the network interface, a second request for state information corresponding to the playback device, wherein the playback device is configured to determine whether the second version of the state information cached in the edge data cache is stale after receipt of the second request for state information.

Example 3: The method of any of Examples 1-2, wherein determining that the first version of state information corresponding to the playback device cached in the edge data cache is stale comprises determining that a time-to-live period for the first version of the state information corresponding to the play back device cached in the edge data cache has expired.

Example 4: The method of any of Examples 1-3, further comprising: after the second version of the state information corresponding to the playback device is cached in the edge data cache, sending, via the network interface to event subscribers, data representing an entity tag indicating the second version of the state information corresponding to the playback device, wherein the event subscribers comprise the network device.

Example 5: The method of any of Examples 1-5, wherein the second request for state information corresponding to the play back device is received via the network interface from an additional network device, and wherein sending the second response comprising second data representing the second version of the state information cached in the edge data cache comprises sending, via the network interface to the additional network device, the second response comprising second data representing the second version of the state information cached in the edge data cache.

Example 6: The method of any of Examples 1-6, further comprising: after receipt of a third request for state information corresponding to the playback device via the network interface, determine that (i) the second version of the state information corresponding to the play back device cached in the edge data cache is not stale and (ii) an entity tag in the third request indicates that a version of the state information on the network device matches the version of the state information in the edge data cache; and based on the determinations that the second version of the state information cached in the edge data cache is not stale and the entity tag in the third request indicates that a version of the state information on the network device matches the version of the state information in the edge data cache, send, via the network interface, a third response comprising a header indicating the state information at the network device is up-to-date, wherein the third response excludes the second data representing the second version of the state information cached in the edge data cache.

Example 7: The method of any of Examples 1-6, wherein the system further comprises the computing system, and wherein the method further comprises: after receiving the data representing the first request for the state information corresponding to the play back device, retrieving, from stored state information for a plurality of media playback systems, the second version of the state information corresponding to the playback device; and sending, via an additional network interface to the media playback system, the data representing the second version of the state information corresponding to the playback device.

Example 8: The method of Example 7, further comprising: after receiving the data representing the first request for the state information corresponding to the playback device, determining that an entity tag in the first request indicates that the playback device has an older version of the state information than the stored state information, wherein the computing system is configured to retrieve, from the stored state information for the plurality of media play back systems, the second version of the state information corresponding to the playback device when the entity tag in the first request indicates that the playback device has an older version of the state information than the stored state information.

Example 9: The method of Example 7, further comprising: after receiving a request for state information corresponding to the playback device via the additional network interface from the network device, retrieving, from the stored state information for the plurality of media playback systems, the second version of the state information corresponding to the playback device, wherein the network device is configured to send requests for state information corresponding to the computing system when the network device is disconnected from the LAN, and wherein the network device is configured to send requests for state information corresponding to the playback device when the network device is connected to the LAN; and sending, via the additional network interface to the network device, the data representing the second version of the state information corresponding to the play back device.

Example 10: The method of any of Examples 1-9, wherein the media play back system comprises an additional playback device, wherein the edge data cache comprises additional state information corresponding to the additional playback device, and wherein the method further comprises: after receiving a request for the additional state information corresponding to the additional playback device via the network interface from the network device, determining that a first version of the additional state information cached in the edge data cache is not stale; and when the first version of the additional state information corresponding to the additional play back device cached in the edge data cache is determined to be not stale, sending, via the network interface to the network device, a response comprising data representing the first version of the additional state information cached in the edge data cache.

Example 11: The method of any of Examples 1-10, wherein the state information comprises data indicating recently-played media items, wherein the second request for state information corresponding to the play back device comprises a request for recently-played media items, and wherein determining that the second version of the state information corresponding to the playback device cached in the edge data cache is not stale comprises determining that a particular portion of the second version of the state information cached in the edge data cache is not stale, wherein the particular portion comprises the data indicating the recently-played media items.

Example 12: The method of any of Examples 1-11, wherein the state information comprises data indicating a topology of the media play back system, the topology comprising (i) play back states of play back devices in the media play back system and (ii) group states correlating play back devices in the media playback system to groupings, wherein the second request for state information corresponding to the playback device comprises a request for the topology of the media play back system, and wherein determining that the second version of the state information corresponding to the playback device cached in the edge data cache is not stale comprises determining that a particular portion of the second version of the state information cached in the edge data cache is not stale, wherein the particular portion comprises the data indicating the topology of the media play back system.

Example 13: The method of any of Examples 1-12, wherein the state information comprises data indicating streaming audio services that are registered with the media play back system, wherein the second request for state information corresponding to the playback device comprises a request for the streaming audio services that are registered with the media playback system, and wherein determining that the second version of the state information corresponding to the play back device cached in the edge data cache is not stale comprises determining that a particular portion of the second version of the state information cached in the edge data cache is not stale, wherein the particular portion comprises the streaming audio services that are registered with the media playback system.

Example 14: The method of any of Examples 1-13, wherein the state information comprises data indicating settings configured in the media play back system, wherein the settings configured in the media play back system comprise at least one of (a) media items designated as favorites or (b) saved playlists, wherein the second request for state information corresponding to the play back device comprises a request for at least one setting configured in the media play back system, and wherein determining that the second version of the state information corresponding to the play back device cached in the edge data cache is not stale comprises determining that a particular portion of the second version of the state information cached in the edge data cache is not stale, wherein the particular portion comprises the settings configured in the media play back system.

Example 16: A tangible, non-transitory, computer-readable medium having instructions stored thereon that are executable by one or more processors to cause a system to perform the method of any one of Examples 1-14.

Example 17: A device comprising a network interface, one or more processors, and a tangible, non-tangible computer-readable medium having instructions stored thereon that are executable by the one or more processors to cause the system to perform the method of any of Examples 1-14.

Example 18: A system comprising a network interface, one or more processors, and a tangible, non-tangible computer-readable medium having instructions stored thereon that are executable by the one or more processors to cause the system to perform the method of any of Examples 1-14.

Example 19: A method to be performed in a system comprising a first playback device, the method comprising: receiving, via a first network interface, first data representing (i) a first play back command and (ii) a first token corresponding to a first client: determining that an edge data cache excludes a token-to-role mapping corresponding to the first token: sending, via the first network interface to a computing system, a request for a role corresponding to the first token: receiving, via the first network interface, a response to the request indicating a first token-to-role mapping that maps the first token to a first role: when the edge data cache excludes the token-to-role mapping corresponding to the first token, caching, in the edge data cache, the first token-to-role mapping that maps the first token to the first role: determining that the edge data cache includes a first role-to-permission mapping corresponding to the first role, wherein the first role-to-permission mapping maps the first role to a first permission set: determining that the first play back command is permitted by the first permission set; and based on determining that the first playback command is permitted by the first permission set, carrying out the first play back command.

Example 20: The method of Example 19, wherein the system further comprises the computing system, and wherein the method further comprises: receiving, via the second network interface, the request for the role corresponding to the first token: determining, based on stored role-to-token mappings for a plurality of media play back systems, the first token-to-role mapping that maps the first token to the first role for the media play back system; and sending, via the second network interface to the play back device, data representing the first token-to-role mapping for the media play back system.

Example 21: The method of any of Examples 19-20, further comprising: after caching the first token-to-role mapping in the edge data cache, receiving, via the first network interface, second data representing (i) a second playback command and (ii) a second token corresponding to the first client: determining that the edge data cache includes the token-to-role mapping corresponding to the first token: determining that the edge data cache includes the first role-to-permission mapping corresponding to the first role: determining that the second play back command is permitted by the first permission set; and based on determining that the second playback command is permitted by the first permission set, carrying out the second play back command.

Example 22: The method of any of Examples 19-21, further comprising: receiving, via the first network interface, third data representing (i) a third playback command and (ii) a second token corresponding to a second client: determining that the edge data cache excludes a token-to-role mapping corresponding to the second token: sending, via the first network interface to the computing system, a request for a role corresponding to the second token: receiving, via the first network interface, a response to the request indicating a second token-to-role mapping that maps the second token to a second role: when the edge data cache excludes the token-to-role mapping corresponding to the second token, caching, in the edge data cache, a second token-to-role mapping that maps the second token to the second role: determining that the edge data cache excludes a second role-to-permission mapping corresponding to the second role: sending, via the first network interface to the computing system, a request for a permission set corresponding to the second role: receiving, via the first network interface, a response to the request indicating a second role-to-permission mapping that maps the second role to a second permission set: when the edge data cache excludes the token-to-role mapping corresponding to the second token, caching, in the edge data cache, the second role-to-permission mapping that maps the second role to the second permission set: determining that the third playback command is permitted by the second permission set; and based on determining that the third playback command is permitted by the second permission set, carrying out the third playback command.

Example 23: The method of Example 22, further comprising: receiving, via the first network interface, fourth data representing (i) a fourth playback command and (ii) the second token corresponding to the second client: determining that the edge data cache includes the token-to-role mapping corresponding to the second token: determining that the edge data cache includes a second role-to-permission mapping corresponding to the second role and that the second role-to-permission mapping is stale as a time-to-live period has expired: sending, via the first network interface to the computing system, a conditional request for a permission set corresponding to the second role, the conditional request indicating a version of the second role-to-permission mapping in the edge data cache: receiving, via the first network interface, a response to the request indicating that the version of the second role-to-permission mapping in the edge data cache matches a version of the second role-to-permission mapping at the computing system: when the response to the request indicating that the version of the second role-to-permission mapping in the edge data cache matches a version of the second role-to-permission mapping at the computing system, re-caching, in the edge data cache, the second role-to-permission mapping that maps the second role to the second permission set for another iteration of the time-to-live period; determining that the fourth playback command is permitted by the second permission set; and based on determining that the fourth playback command is permitted by the second permission set, carrying out the fourth play back command.

Example 24: The method of any of Examples 19-23, wherein the system further comprises the computing system, and wherein the method further comprises: receiving, via the second network interface, the request for the permission set corresponding to the second role; determining, based on stored role-to-permission mappings, the second role-to-permission mapping that maps the second role to the second permission set; and sending, via the second network interface to the playback device, data representing the second role-to-permission mapping.

Example 25: The method of any of Examples 19-24, further comprising: before determining that the edge data cache includes the first role-to-permission mapping corresponding to the first role, sending, via the first network interface, a request for the first permission set corresponding to the first role; and caching, in the edge data cache, the first role-to-permission mapping that maps the first role to the first permission set.

Example 26: The method of any of Examples 19-25, wherein the first client comprises an application executing on a mobile device, and wherein the functions further comprise: sending, via the first network interface to the mobile device, data representing a result of the first playback command, wherein the data representing the result of the first playback command causes the application to update a graphical user interface displayed on the mobile device to indicate the result of the first playback command.

Example 27: The method of any of Examples 19-26, wherein the first play back command is a volume adjustment command, and wherein the first permission set comprises a first permission mask comprising digits settable to values corresponding to a read permission or a modify permission, the digits comprising a volume permission digit, and wherein determining that the first playback command is permitted by the first permission set comprises determining that the volume permission digit indicates a value corresponding to the modify permission.

Example 28: The method of any of Examples 19-27, wherein receiving the first data representing the first playback command comprises receiving data representing a first universal plug- and play (UPnP) command, and wherein determining that the first playback command is permitted by the first permission set comprises: mapping the first UPnP command to a corresponding first media playback system command; and determining that the first media play back system command is permitted by the first permission set.

Example 29: The method of any of Examples 19-28, further comprising: receiving, via the first network interface, fifth data representing (i) a fifth playback command, wherein the fifth data excludes a token: determining that the edge data cache excludes a token-to-role mapping corresponding to a token absence: sending, via the first network interface to the computing system, a request for a role corresponding to the token absence: receiving, via the first network interface, a response to the request indicating a token-to-role mapping that maps the token absence to the first role: determining that the edge data cache includes the first role-to-permission mapping corresponding to the first role: determining that the fourth play back command is prohibited by the first permission set; and based on determining that the fourth playback command is prohibited by the first permission set, foregoing carrying out the fourth play back command.

Example 30: The method of any of Examples 19-29, wherein carrying out the first playback command comprises causing at least one additional playback device of the media play back system to carry out the first play back command.

Example 31: The method of any of Examples 19-30, wherein the system further comprises the computing system, and wherein the method further comprises: validating the first token, and wherein determining the first token-to-role mapping that maps the first token to the first role for the media play back system comprises determining a particular first token-to-role mapping that maps the validated first token to the first role for the media play back system, wherein an invalid token maps to another role that is different from the first role.

Example 32: The method of any of Examples 19-31, further comprising: before determining that the edge data cache includes the first role-to-permission mapping corresponding to the first role, sending, via the first network interface to the computing system, an if-modified-since request for a role-to-permission mapping corresponding to the first role, the if-modified-since request indicating a particular time and date:

Example 33: The method of any preceding Example, receiving, via the first network interface, a response to the if-modified-since request indicating that the role-to-permission mapping corresponding to the first role is modified since the particular time and date, wherein the response indicates the first role-to-permission mapping that maps the first role to the first permission set; and caching, in the edge data cache, the first role-to-permission mapping that maps the first role to the first permission set.

Example 34: A tangible, non-transitory, computer-readable medium having instructions stored thereon that are executable by one or more processors to cause a system to perform the method of any one of Examples 19-33.

Example 35: A device comprising a network interface, one or more processors, and a tangible, non-tangible computer-readable medium having instructions stored thereon that are executable by the one or more processors to cause the system to perform the method of any of Examples 19-33.

Example 36: A system comprising a network interface, one or more processors, and a tangible, non-tangible computer-readable medium having instructions stored thereon that are executable by the one or more processors to cause the system to perform the method of any of Examples 19-33.

1.-17. (canceled)

18. A system comprising a playback device in a media playback system, the playback device comprising:
a network interface;
at least one processor; and
data storage comprising an edge data cache;
at least one non-transitory computer-readable medium comprising program instructions that are executable by the at least one processor such that the playback device is configured to:
determine that a first version of state information corresponding to the playback device cached in the edge data cache is stale, wherein the playback device is connected to a local area network (LAN);
after determining that the first version of the state information cached in the edge data cache is stale, send, via the network interface to a computing system, data representing a first request for the state information corresponding to the playback device, wherein the computing system is outside of the LAN;
after receipt of data representing a second version of the state information corresponding to the playback device, cache, in the edge data cache, the second version of the state information of the state information corresponding to the playback device;
send, via the network interface to a network device, a first response comprising first data representing the second version of the state information;
determine that the second version of the state information corresponding to the playback device cached in the edge data cache is not stale; and
after determining that the second version of the state information cached in the edge data cache is not stale, send, via the network interface, a second response comprising second data representing the second version of the state information cached in the edge data cache.

19. The system of claim 18, wherein the at least one non-transitory computer-readable medium further comprises program instructions that are executable by the at least one processor such that the playback device is further configured to:
receive, via the network interface, a first request for state information corresponding to the playback device, wherein the playback device is configured to determine whether the first version of the state information cached in the edge data cache is stale after receipt of the first request for state information; and
receive, via the network interface, a second request for state information corresponding to the playback device, wherein the playback device is configured to determine whether the second version of the state information cached in the edge data cache is stale after receipt of the second request for state information.

20. The system of claim 18, wherein the program instructions that are executable by the at least one processor such that the playback device is configured to determine that the first version of state information corresponding to the playback device cached in the edge data cache is stale comprise program instruction that are executable by the at least one processor such that the playback device is configured to:
determine that a time-to-live period for the first version of the state information corresponding to the playback device cached in the edge data cache has expired.

21. The system of claim 18, wherein the at least one non-transitory computer-readable medium further comprises program instructions that are executable by the at least one processor such that the playback device is further configured to:
after the second version of the state information corresponding to the playback device is cached in the edge data cache, send, via the network interface to event subscribers, data representing an entity tag indicating the second version of the state information corresponding to the playback device, wherein the event subscribers comprise the network device.

22. The system of claim 18, wherein the second request for state information corresponding to the playback device is received via the network interface from an additional network device, and wherein the program instructions that are executable by the at least one processor such that the playback device is configured to send the second response comprising second data representing the second version of the state information cached in the edge data cache comprise program instruction that are executable by the at least one processor such that the playback device is configured to:
send, via the network interface to the additional network device, the second response comprising second data representing the second version of the state information cached in the edge data cache.

23. The system of claim 18, wherein the at least one non-transitory computer-readable medium further comprises program instructions that are executable by the at least one processor such that the playback device is further configured to:
after receipt of a third request for state information corresponding to the playback device via the network interface, determine that (i) the second version of the state information corresponding to the playback device cached in the edge data cache is not stale and (ii) an entity tag in the third request indicates that a version of the state information on the network device matches the version of the state information in the edge data cache; and
based on the determinations that the second version of the state information cached in the edge data cache is not stale and the entity tag in the third request indicates that a version of the state information on the network device matches the version of the state information in the edge data cache, send, via the network interface, a third response comprising a header indicating the state information at the network device is up-to-date, wherein the third response excludes the second data representing the second version of the state information cached in the edge data cache.

24. The system of claim 18, wherein the system further comprises the computing system, and wherein the computing system comprises:
an additional network interface;
at least one additional processor; and
at least one additional tangible, non-transitory computer-readable medium comprising additional program instructions that are executable by the at least one additional processor such that the computing system is configured to:
after receipt of the data representing the first request for the state information corresponding to the playback device, retrieve, from stored state information for a plurality of media playback systems, the second version of the state information corresponding to the playback device; and
send, via the additional network interface to the media playback system, the data representing the second version of the state information corresponding to the playback device.

25. The system of claim 24, wherein the at least one additional non-transitory computer-readable medium further comprises program instructions that are executable by the at least one additional processor such that the computing system is further configured to:
after receipt of the data representing the first request for the state information corresponding to the playback device, determine that an entity tag in the first request indicates that the playback device has an older version of the state information than the stored state information, wherein the computing system is configured to retrieve, from the stored state information for the plurality of media playback systems, the second version of the state information corresponding to the playback device when the entity tag in the first request indicates that the playback device has an older version of the state information than the stored state information.

26. The system of claim 24, wherein the at least one additional non-transitory computer-readable medium further comprises additional program instructions that are executable by the at least one additional processor such that the computing system is further configured to:
after receipt of a request for state information corresponding to the playback device via the additional network interface from the network device, retrieve, from the stored state information for the plurality of media playback systems, the second version of the state information corresponding to the playback device, wherein the network device is configured to send requests for state information corresponding to the computing system when the network device is disconnected from the LAN, and wherein the network device is configured to send requests for state information corresponding to the playback device when the network device is connected to the LAN; and
send, via the additional network interface to the network device, the data representing the second version of the state information corresponding to the playback device.

27. The system of claim 18, wherein the media playback system comprises an additional playback device, wherein the edge data cache comprises additional state information corresponding to the additional playback device, and wherein the at least one non-transitory computer-readable medium further comprises program instructions that are executable by the at least one processor such that the playback device is further configured to:
after receipt of a request for the additional state information corresponding to the additional playback device via the network interface from the network device, determine that a first version of the additional state information cached in the edge data cache is not stale; and
when the first version of the additional state information corresponding to the additional playback device cached in the edge data cache is determined to be not stale, send, via the network interface to the network device, a response comprising data representing the first version of the additional state information cached in the edge data cache.

28. The system of claim 18, wherein the state information comprises data indicating recently-played media items, wherein the second request for state information corresponding to the playback device comprises a request for recently-played media items, and wherein the program instructions that are executable by the at least one processor such that the playback device is configured to determine that the second version of the state information corresponding to the playback device cached in the edge data cache is not stale comprise program instruction that are executable by the at least one processor such that the playback device is configured to:
determine that a particular portion of the second version of the state information cached in the edge data cache is not stale, wherein the particular portion comprises the data indicating the recently-played media items.

29. The system of claim 18, wherein the state information comprises data indicating a topology of the media playback system, the topology comprising (i) playback states of playback devices in the media playback system and (ii) group states correlating playback devices in the media playback system to groupings, wherein the second request for state information corresponding to the playback device comprises a request for the topology of the media playback system, and wherein the program instructions that are executable by the at least one processor such that the playback device is configured to determine that the second version of the state information corresponding to the playback device cached in the edge data cache is not stale comprise program instruction that are executable by the at least one processor such that the playback device is configured to:
determine that a particular portion of the second version of the state information cached in the edge data cache is not stale, wherein the particular portion comprises the data indicating the topology of the media playback system.

30. The system of claim 18, wherein the state information comprises data indicating streaming audio services that are registered with the media playback system, wherein the second request for state information corresponding to the playback device comprises a request for the streaming audio services that are registered with the media playback system, and wherein the program instructions that are executable by the at least one processor such that the playback device is configured to determine that the second version of the state information corresponding to the playback device cached in the edge data cache is not stale comprise program instruction that are executable by the at least one processor such that the playback device is configured to:
determine that a particular portion of the second version of the state information cached in the edge data cache is not stale, wherein the particular portion comprises the streaming audio services that are registered with the media playback system.

31. The system of claim 18, wherein the state information comprises data indicating settings configured in the media playback system, wherein the settings configured in the media playback system comprise at least one of (a) media items designated as favorites or (b) saved playlists, wherein the second request for state information corresponding to the playback device comprises a request for at least one setting configured in the media playback system, and wherein the program instructions that are executable by the at least one processor such that the playback device is configured to determine that the second version of the state information corresponding to the playback device cached in the edge data cache is not stale comprise program instruction that are executable by the at least one processor such that the playback device is configured to:
determine that a particular portion of the second version of the state information cached in the edge data cache is not stale, wherein the particular portion comprises the settings configured in the media playback system.

32. A system comprising a playback device in a media playback system and a network device, the playback device comprising:
a first network interface;
at least one first processor; and
at least one first non-transitory computer-readable medium comprising an edge data cache and first program instructions that are executable by the at least one first processor such that the playback device is configured to:
after receipt of a first request for state information corresponding to the playback device via the first network interface, determine that a first version of state information corresponding to the playback device cached in the edge data cache is stale, wherein the playback device is connected to a local area network (LAN);
when the first version of the state information cached in the edge data cache is determined to be stale, send, via the first network interface to a computing system, data representing the first request for the state information corresponding to the playback device, wherein the computing system is outside of the LAN;
after receipt of data representing a second version of the state information corresponding to the playback device, cache, in the edge data cache, the second version of the state information of the state information corresponding to the playback device;
send, via the first network interface to the network device on a mobile device, a first response comprising first data representing the second version of the state information;
after receipt of a second request for state information corresponding to the playback device via the first network interface, determine that the second version of the state information corresponding to the playback device cached in the edge data cache is not stale; and
when the second version of the state information cached in the edge data cache is determined to be not stale, send, via the first network interface, a second response comprising second data representing the second version of the state information cached in the edge data cache; and
wherein the network device comprises:
at least one second processor; and
at least one second non-transitory computer-readable medium comprising second program instructions that are executable by the at least one second processor such that the network device is configured to:
send, via a second network interface, the first request for state information corresponding to the playback device; and
after receipt of the first response comprising first data representing the second version of the state information, cause a graphical user interface to display graphical indications of at least a portion of states represented by the second version of the state information.

33. The system of claim 32, wherein the at least one first non-transitory computer-readable medium further comprises first program instructions that are executable by the at least one first processor such that the playback device is further configured to:
receive, via the first network interface, a first request for state information corresponding to the playback device, wherein the playback device is configured to determine whether the first version of the state information cached in the edge data cache is stale after receipt of the first request for state information; and
receive, via the first network interface, a second request for state information corresponding to the playback device, wherein the playback device is configured to determine whether the second version of the state information cached in the edge data cache is stale after receipt of the second request for state information.

34. The system of claim 32, wherein the first program instructions that are executable by the at least one first processor such that the playback device is configured to determine that the first version of state information corresponding to the playback device cached in the edge data cache is stale comprise first program instructions that are executable by the at least one first processor such that the playback device is configured to:
determine that a time-to-live period for the first version of the state information corresponding to the playback device cached in the edge data cache has expired.

35. The system of claim 32, wherein the at least first one non-transitory computer-readable medium further comprises first program instructions that are executable by the at least one first processor such that the playback device is further configured to:
after the second version of the state information corresponding to the playback device is cached in the edge data cache, send, via the first network interface to event subscribers, data representing an entity tag indicating the second version of the state information corresponding to the playback device, wherein the event subscribers comprise the network device.

36. The system of claim 32, wherein the second request for state information corresponding to the playback device is received via the first network interface from an additional network device, and wherein the first program instructions that are executable by the at least one first processor such that the playback device is configured to send the second response comprising second data representing the second version of the state information cached in the edge data cache comprise first program instructions that are executable by the at least one first processor such that the playback device is configured to:
send, via the first network interface to the additional network device, the second response comprising second data representing the second version of the state information cached in the edge data cache.

36. A tangible non-transitory computer-readable medium comprising program instructions that are executable by at least one processor such that a playback device is configured to:
determine that a first version of state information corresponding to the playback device cached in an edge data cache is stale, wherein the playback device is connected to a local area network (LAN), and wherein the playback device comprises the edge data cache;
after determining that the first version of the state information cached in the edge data cache is stale, send, via a network interface to a computing system, data representing a first request for the state information corresponding to the playback device, wherein the computing system is outside of the LAN;
after receipt of data representing a second version of the state information corresponding to the playback device, cache, in the edge data cache, the second version of the state information of the state information corresponding to the playback device;
send, via the network interface to a network device, a first response comprising first data representing the second version of the state information;
determine that the second version of the state information corresponding to the playback device cached in the edge data cache is not stale; and
after determining that the second version of the state information cached in the edge data cache is not stale, send, via the network interface, a second response comprising second data representing the second version of the state information cached in the edge data cache.
